(19) United States
(12) Patent Application Publication
(10) Pub. No.: US 2026/0124095 A1
(43) Pub. Date: May 7, 2026

(54) Methods, Systems, and Apparatuses for Implementing Neuroprosthesis for Mobility Assistance

(71) Applicants: The United States Government as represented by the Department of Veterans Affairs, Washington, DC (US); CASE WESTERN RESERVE UNIVERSITY, Cleveland, OH (US)

(72) Inventors: Nathaniel S. Makowski, Cleveland, OH (US); Lisa M. Lombardo, Chardon, OH (US); Rodger Quinn, Akron, OH (US); Ronald J. Triolo, Cleveland Heights, OH (US); Ryan Reyes, Tallahassee, FL (US); Musa L. Audu, Shaker Heights, OH (US); Marshaun N. Fitzpatrick, Oberlin, OH (US)

(21) Appl. No.: 19/119,322

(22) PCT Filed: Oct. 16, 2023
(86) PCT No.: PCT/US2023/076983

§ 371 Date: Apr. 8, 2025

Related U.S. Application Data
(60) Provisional application No. 63/416,306, filed on Oct. 14, 2022.

(51) Int. Cl. A61H 3/00; A61H 1/02; B25J 9/00

(52) U.S. Cl. CPC A61H 3/00; A61H 1/0262; B25J 9/0006; A61H 2003/007; A61H 2201/1215; A61H 2201/5007

(57) ABSTRACT

Methods, systems, and/or apparatuses are provided for providing multi-joint assistance for and/or resistance against leg movement of a user. The assistance may be provided to a paretic leg or a prosthetic leg of the user. Kinematic data associated with the paretic or prosthetic leg of the user may be received. The data may include one or more of velocity data, position data, orientation data, or acceleration data for differing portions of the paretic or prosthetic leg. A current phase of a gait motion for the paretic or prosthetic leg may be determined based on the kinematic data. One or more of electrical stimuli or motorized assistance or resistance may be provided to the paretic leg, prosthetic leg, or the remaining portion of the amputated leg based on the current phase of the gait motion of the paretic or prosthetic leg.

### CROSS-REFERENCE TO RELATED APPLICATIONS

This Application claims priority to and the benefit of U.S. Provisional Patent Application No. 63/416,306, filed Oct. 14, 2022, the entire contents of which are hereby incorporated herein by reference in its entirety.

### BACKGROUND

Stroke survivors as well as those with other ailments may suffer from partial paralysis or reduced capabilities in one of their legs (e.g., a paretic leg). These people may have difficulty walking or relearning to walk without some sort of assistance. Providing motorized assistance or electrical stimulation to portions of the paretic leg through different portions of the gait cycle has the potential to substantially improve walking. Furthermore, due to paralysis or other factors, the leg muscles of the paretic leg may be weak or have limited endurance. In addition, while these people have some ability to move their paretic leg during a gait motion, that movement may not be in a proper trajectory for one or more phases of the gait motion. This may result in an increased potential for the person to fall or become tired more easily because their trajectory during the gait motion is inefficient.

### SUMMARY

Described herein, in various aspects, are methods, systems, and apparatuses configured to provide multi-joint assistance for walking. For example, multi-joint assistance may be provided by an apparatus that is removably coupled to a leg of a person (i.e., survivor or user). For example, the leg may be a paretic leg of the user who has previously suffered a stroke or other ailment.

In certain examples, the apparatus may comprise a neuroprosthesis, exoskeleton, or brace (hereinafter referred to as a brace). The brace may comprise a thigh section, a shank section, and a foot support section. The thigh section and the shank section may be movably coupled to one another and the shank section and the foot support section may be movably coupled to one another. The brace may comprise a motor configured to provide motorized assistance between the thigh section and the shank section. The brace may comprise one or more electrodes and an electrical power source electrically coupled thereto. The one or more electrodes may be configured to provide electrical stimuli to a thigh portion and/or shank portion of the paretic leg of the user. The brace may comprise one or more sensors configured to determine kinematic information associated with all or a particular portion of the paretic leg. For example, the brace may comprise one or more of a thigh sensor, a shank sensor, or a heel strike sensor. For example, heel strike sensors may be provided for both the foot of the paretic leg and the foot of the non-paretic leg of the user. The brace may comprise one or more devices or mechanisms for attaching the brace to the paretic leg of the user. The apparatus may comprise a control computing device. The control computing device may be a computer configured to receive sensor data from the one or more sensors and determine to initiate, terminate, reduce, or modify one or more of the motorized assistance or the electrical stimuli to all or a portion of the paretic leg.

In certain examples, a method for providing assistance to a paretic leg may be provided. The method may comprise receiving sensor data associated with a paretic leg. The sensor data may be received by a computing device, such as the control computing device or a user device (e.g., a smartphone, tablet, smartwatch, mobile computer, laptop computer, etc.). A current phase of the gait motion of the paretic leg may be determined. For example, the current phase may be determined based on the sensor data. One or both of electrical stimuli or motorized assistance may be provided by the brace to the paretic leg. For example, the electrical stimuli and/or the motorized assistance may be provided based on the current phase of the gait motion of the paretic leg.

In certain examples, a method for providing assistance to a paretic leg may be provided. The method may comprise receiving sensor data for a paretic leg of a user. The method may comprise determining that the paretic leg is in a stance phase of a gait motion for the paretic leg. For example, the paretic leg may be determined to be in the stance phase based on sensor data. The method may comprise providing one or both of electrical stimuli and/or motorized assistance to the paretic leg for the stance phase of the gait motion.

In certain examples, a method for providing resistance to a paretic leg may be provided. The method may comprise receiving sensor data for the paretic leg of the user. A determination may be made that the paretic leg is beginning a swing phase of a gait motion. For example, the determination may be based on the sensor data. The method may comprise determining a first direction of motion for a portion of the paretic leg. For example, the first direction of motion may be determined based on the paretic leg beginning the swing phase. The method may comprise providing a resistive force against the portion of the paretic leg. The resistive force may be provided in a direction opposite to the first direction of motion. The resistive force may be provided by the neuroprosthesis, exoskeleton, or brace coupled to the paretic leg.

In certain examples, a method for providing assistance to a paretic leg may be provided. The method may comprise receiving first sensor data for a non-paretic leg of a first person. For example, the first sensor data may be received by a computing device. The method may comprise determining a first trajectory of a swing phase for the non-paretic leg of the first person. For example, the first trajectory may be determined based on the first sensor data. The method may comprise receiving second sensor data for a paretic leg of a second person. For example, the second sensor data may be received by the computing device. The method may comprise determining a second trajectory of a second swing phase for the paretic leg of the second person. For example, the second trajectory may be determined based on the second sensor data. The method may comprise determining that the second trajectory does not match the first trajectory. The method may comprise providing at least one of electrical stimuli or motorized assistance to the paretic leg for a third swing phase. For example, the assistance may be provided based on the second trajectory for the paretic leg of the second person not matching the first trajectory of the non-paretic leg of the first person.

This summary is not intended to identify critical or essential features of the disclosure, but merely to summarize certain features and variations thereof. Other details and features will be described in the sections that follow. Additional advantages of the disclosure will be set forth in part in the description that follows, and in part will be obvious from the description, or may be learned by practice of the concepts described in this disclosure. The advantages of the concepts described in this disclosure will be realized and attained by means of the elements and combinations particularly pointed out in the appended claims. It is to be understood that both the foregoing general description and the following detailed description are exemplary and explanatory only and do not restrict the scope of the claims.

### DESCRIPTION OF THE DRAWINGS

The accompanying drawings, which are incorporated in and constitute a part of the present description serve to explain the principles of the methods, apparatuses, and systems described herein:

FIG. 1 shows an example system for providing mechanical or electrical assistance for leg movement;

FIG. 2 shows an example system for providing electrical assistance for leg movement;

FIG. 3 shows an example system for providing assistance for prosthetic leg movement;

FIG. 4 shows an example method for providing assistance for leg movement;

FIG. 5 shows an example method for providing assistance for leg movement;

FIG. 6 shows an example method for providing motorized resistance against leg movement;

FIG. 7 shows an example method for providing assistance for leg movement; and

FIG. 8 shows example system for providing mechanical or electrical assistance for leg movement.

### DETAILED DESCRIPTION

Before the present methods, systems, and apparatuses are disclosed and described, it is to be understood that the methods, systems, and apparatuses are not limited to specific methods, specific components, or to particular implementations. It is also to be understood that the terminology used herein is for the purpose of describing particular embodiments only, and is not intended to be limiting.

As used in the specification and the appended claims, the singular forms “a,” “an” and “the” include plural referents unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Furthermore, descriptions of an event or circumstance without use of “optional” or “optionally” does not mean that the described event does occur, must occur, or is necessary to the operation of the apparatus or system or required for the performance of the method.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods, apparatuses, and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

The present methods, systems, and apparatuses may be understood more readily by reference to the following detailed description of example embodiments and the examples included therein and to the figures and their previous and following description.

As will be appreciated by one skilled in the art, one or more of the methods, systems, and apparatuses described herein may take the form of an entirely hardware embodiment, an entirely software embodiment, or an embodiment combining software and hardware aspects. Furthermore, the methods, systems, and apparatuses may take the form of a computer program product on a computer-readable storage medium (e.g., a non-transitory computer-readable medium) and having computer-readable program instructions (e.g., computer software) embodied in the storage medium. Any suitable computer-readable storage medium (e.g., a non-transitory computer-readable medium) may be utilized including hard disks, CD-ROMs, optical storage devices, flash drive, SD card or similar non-volatile memory card, or magnetic storage devices.

Embodiments of the methods, systems, and apparatuses are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a microcontroller, general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce functions on an article of manufacture including computer-readable instructions for implementing the function specified in the flowchart block or blocks. The computer program instructions may also be loaded onto a microcontroller, computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems or one or more microcontrollers that perform the specified functions or steps, or combinations of special purpose hardware and computer instructions.

Hereinafter, various embodiments of the present disclosure will be described with reference to the accompanying drawings. As used herein, the term “user” may indicate a person.

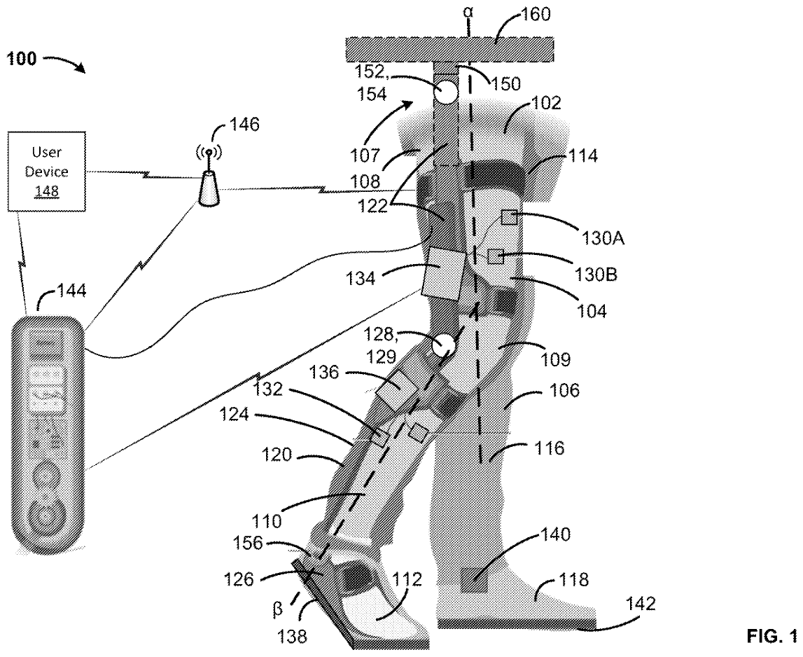

FIG. 1 shows an example system 100 for providing mechanical and/or electrical assistance for leg movement. For example, the assistance may be provided to a user 102, such as a person. The user 102 may have a paretic leg 104 (e.g., a leg suffering partial paralysis) and a non-paretic leg 106. While the example of FIG. 1 shows the right leg of the user 102 being the paretic leg 104, this is for example purposes only. The paretic leg 104 may have been caused by a stroke or other ailment or injury suffered by the user 102.

The paretic leg 104 may comprise a pelvic portion 107, a thigh portion 108, a knee portion 109, a shank portion 110, and a foot 112. For example, the thigh portion 108 may be the portion of the paretic leg 104 between the pelvic portion 107 (e.g., the pelvis) and the knee portion 109 of the paretic leg 104. For example, the shank portion 110 may be the portion of the paretic leg 104 between the knee portion 109 and the foot 112 of the paretic leg 104. The knee portion 109 may be the portion of the paretic leg 104 providing an axis of rotation for the shank portion 110 with respect to the thigh portion 108. A hip may be the portion of the paretic leg 104 providing an axis of rotation for the thigh portion 108 with respect to the pelvic portion 107.

The non-paretic leg 106 may comprise a thigh portion 114, a shank portion 116, and a foot 118. For example, the thigh portion 114 may be the portion of the non-paretic leg 106 between the pelvis and the knee of the non-paretic leg 106. For example, the shank portion 116 may be the portion of the non-paretic leg 106 between the knee and the foot 118 of the non-paretic leg 106.

The system 100 may comprise a neuroprosthesis, exoskeleton, or brace 120 (referred to hereinafter as the brace 120). For example, the brace 120 may be a leg brace. For example, the brace 120 may be configured to be attached to the paretic leg 104 of the user 102. The brace 120 may be made of one or more of plastic or metal components. For example, the brace 120 may comprise one or more straps, belts, or the like for removably attaching the brace 120 to the paretic leg 104 or another portion (e.g., the waist) of the user 102. For example, the one or more straps may comprise hook and loop straps that provide adjustability in attaching the brace 120 to the paretic leg 104 or other portion of the user 102.

The brace 120 may comprise one or more sections. For example, the brace 120 may comprise a thigh section 122, a shank section 124, and a foot support section 126. In certain examples, the brace 120 may also comprise a hip section 150, and a waist section 160 for attaching the brace 120 around the user's waist. The thigh section 122 may be movably coupled to the shank section 124 and may be configured to move or rotate with respect to the shank section 124. In certain examples, the thigh section 122 may also be movably coupled to the hip section 150 and may be configured to move or rotate with respect to the hip section 150. The thigh section 122 may include an elongated support member. The elongated support member may be configured to extend along at least a portion of the thigh portion (e.g., upper leg) 108 of the user 102. For example, the thigh section 122 may be configured to be positioned along an outer side of the thigh portion 108 of the paretic leg 104. The thigh section 122 may comprise one or more straps, belts, or the like for removably attaching the thigh section 122 to the thigh portion 108 of the paretic leg 104. For example, the one or more straps may comprise hook and loop straps that provide adjustability in attaching the thigh section 122 to the thigh portion 108.

The shank section 124 may be movably coupled to the thigh section 122 and may be configured to move or rotate with respect to the thigh section 122. The shank section 124 may be movably coupled to the foot support section 126 and may be configured to move or rotate with respect to the foot support section 126. The shank section 122 may include an elongated support member. The elongated support member may be configured to extend along at least a portion of the shank portion (e.g., lower leg) 110 of the paretic leg 104. For example, the shank section 124 may be configured to be positioned along an outer side and/or back side of the shank portion 110 of the paretic leg 104. The shank section 124 may comprise one or more straps, belts, or the like for removably attaching the shank section 124 to the shank portion 110 of the paretic leg 104. For example, the one or more straps may comprise hook and loop straps that provide adjustability in attaching the shank section 124 to the shank portion 110 of the paretic leg 104.

The foot support section 126 may be movably coupled to the shank section 124 and may be configured to move or rotate with respect to the shank section 124. The foot support section 126 may include one or more panels. The one or more panels may comprise a bottom panel configured to contact a bottom side of the foot 112 of the paretic leg 104. The one or more panels may also comprise one or more side panels or a rear panel extending up from the bottom panel and configured to be positioned along an outer perimeter of the foot 112. The foot support section 126 may comprise one or more straps, belts, or the like for removably attaching the foot support section 126 to the foot 112 of the user 102. For example, the one or more straps may comprise hook and loop straps that provide adjustability in attaching the foot support section 126 to the foot 112.

The hip section 150 may be movably coupled to the thigh section 122 and may be configured to move or rotate with respect to the thigh section 122. The hip section 150 may extend from the thigh section 122 to the waist section 160. The hip section 150 may include a support member (e.g., an elongated support member). The support member may be configured to extend along at least a portion of the pelvic portion 107 of the paretic leg 104. For example, the hip section 150 may be configured to be positioned along an outer side of the pelvic portion 107 of the paretic leg 104.

The waist section 160 may be coupled to the hip section 150. The waist section 160 may be configured to extend around the waist or trunk/torso of the user 102. The waist section 160 may comprise one or more straps, belts, or the like for removably attaching the waist section 160 around the waist/torso/trunk of the user 102. For example, the one or more straps may comprise hook and loop straps that provide adjustability in attaching the waist section 160 to the waist/torso/trunk of the user 102.

The brace 120 may comprise one or more motors 128. The one or more motors 128 may be positioned at or near an axis of rotation between the thigh section 122 and the shank section 124. In certain examples, another one or more motors 152 may be positioned at or near an axis of rotation between the thigh section 122 and the hip section 150. For example, the one or more motors 152 may be provided for users 102 that have limited active hip motion. In certain examples, additional motors may be provided, such as a motor between the shank section 124 and the foot support section 126 to control rotation of the foot 112 with respect to the shank section 110 of the paretic leg 104. The one or more motors 128 may be configured to provide motorized assistance with respect to the shank portion 110 rotating with respect to the thigh portion 108 of the paretic leg 104 by providing motorized assistance for the shank section 124 to rotate with respect to the thigh section 122 of the brace 120. In other examples, the one or more motors 128 may be configured to provide motorized resistance with respect to the shank portion 110 rotating with respect to the thigh portion 108 by providing motorized resistance against the shank section 124 rotating with respect to the thigh section 122 of the brace 120. The one or more motors 152 may be configured to provide motorized assistance with respect to the thigh portion 108 rotating with respect to the pelvic portion 107 of the paretic leg 104 by providing motorized assistance for the thigh section 122 to rotate with respect to the hip section 150 of the brace 120. While one example of providing motorized assistance for the thigh portion 108 with respect to the pelvic portion 107, other examples are possible. For example, cabling could be attached to textiles worn on the leg of the user 102 to generate the torques for mobilizing the thing portion 108 with respect to the pelvic portion 107. For example, the one or more motors 152 may provide motorized assistance with hip flexion at the end of the terminal stance phase and then during early, mid, and terminal swing. Motorized assistance may reduce during terminal swing and the one or more motors 152 may provide motorized assistance with hip/thigh extension from heel strike to midstance. In other examples, the one or more motors 152 may be configured to provide motorized resistance with respect to the thigh portion 108 rotating with respect to the pelvic portion 107 by providing motorized resistance against the thigh section 122 rotating with respect to the hip section 150 of the brace 120. The motorized resistance may be provided in order to help build muscle strength in one or more portions of the paretic leg 104.

The one or more motors 128 may include or be operably coupled to a sensor 129. For example, the sensor 129 may be an encoder. The sensor 129 may provide rotational data indicating the amount of rotation of the shank portion 110 with respect to the thigh portion 108 of the paretic leg 104. The one or more motors 128 and the sensor 129 may be electrically coupled to a power source (not shown). The one or more motors 152 may include or be operably coupled to a sensor 154. For example, the sensor 154 may be an encoder. The sensor 154 may provide rotational data indicating the amount of rotation of the thigh portion 108 with respect to the pelvic portion 107 of the paretic leg 104. The one or more motors 152 and the sensor 154 may be electrically coupled to a power source (not shown). The power source may be coupled to the brace 120 and may be configured to provide electrical power to one or more components of the brace 120.

For example, the power source may be a battery or battery pack, such as a rechargeable battery. For example, the power source may be one or more of a lead-acid rechargeable battery, a nickel-cadmium rechargeable battery, a nickel-metal hydride rechargeable battery, or a lithium-ion rechargeable battery.

The brace 120 may comprise an ankle sensor 156. For example, the ankle sensor 156 may be an encoder. The ankle sensor 156 may provide rotational data indicating the amount of rotation of the foot 112 with respect to the shank portion 110 of the paretic leg 104. The ankle sensor 156 may be electrically coupled to the power source for the brace 120.

The brace 120 may comprise one or more electrodes 130A-B, 132. The one or more electrodes 130A-B may be positioned at one or more locations along the outer surface of the thigh portion 108 of the paretic leg 104. The one or more electrodes 132 may be positioned at one or more locations along the outer surface of the shank portion 110 of the paretic leg 104. Additional electrodes (not shown) may be positioned along these and/or other portions of the paretic leg, such as along the pelvic portion 107 and/or the knee portion 109. The one or more electrodes 130A-B, 132 may be configured to provide electrical stimuli to the muscles of the thigh portion 108 and/or shank portion 110 and/or any other portion or portions of the paretic leg 104 in order to provide assistance with rotation and/or movement of the thigh portion 108 and/or shank portion 110 of the leg 104 during movement. The one or more electrodes 130A-B, 132 may be operably coupled to one or more of the sensors 129, 154, 156. The sensor 129 may provide rotational data indicating the amount of rotation of the shank section 124 with respect to the thigh section 122. The sensor 154 may provide rotational data indicating the amount of rotation of the thigh section 122 with respect to the hip section 150. The one or more electrodes 130A-B, 132 may be electrically coupled to the power source.

The brace 120 may comprise a thigh sensor 134. The thigh sensor 134 may be positioned along a portion of the thigh section 122 of the brace 120. For example, the thigh sensor 134 may be coupled to the elongated member of the thigh section 122. For example, the thigh sensor 134 may be an inertial measurement unit or another form of sensor. For example, the thigh sensor 134 may comprise multiple sensors for detecting certain data related to the thigh portion 108 of the paretic leg 104. For example, the thigh sensor 134 may generate or collect data related to the thigh portion 108, the data comprising one or more of acceleration data indicating an acceleration for the thigh portion 108, velocity data (e.g., angular velocity data) indicating a velocity or angular velocity for the thigh portion 108, orientation data indicating an orientation of the thigh portion 108, and/or position data indicating a position of the thigh portion 108 (e.g., position of the thigh portion 108 with respect to the hip or pelvis of the paretic leg 104 or the position of the thigh portion 108 with respect to the shank portion 110 of the paretic leg 104). For example, the thigh sensor 134 may collect data related to the muscle activity along the thigh portion 108 of the paretic leg 104. The muscle activity data may indicate a muscle activity level for the thigh portion 108. The muscle activity level may be compared to a muscle activity threshold. If the muscle activity level satisfies (e.g., is greater than or greater than or equal to) the muscle activity threshold the muscle activity level may indicate an initiation of a phase of the gate cycle and/or a transition from one phase to another phase of the gait cycle.

For example, the orientation data may indicate an angle of orientation of the thigh portion 108 as taken along an elongated axis (a) of the thigh portion 108 as compared to a vertical axis or a horizontal axis. The thigh sensor 134 may be electrically coupled to the power source. The thigh sensor 134 may be communicably coupled to the control computing device 144 and may send one or more of the acceleration data, velocity data (e.g., angular velocity data), orientation data, muscle activity data, and/or position data to the control computing device 144 and/or the user device 148.

The brace 120 may comprise a shank sensor 136. The shank sensor 136 may be positioned along a portion of the shank section 124 of the brace 120. For example, the shank sensor 136 may be coupled to the elongated member of the shank section 124. For example, the shank sensor 136 may be an inertial measurement unit or another form of sensor. For example, the shank sensor 136 may comprise multiple sensors for detecting certain data related to the shank portion 110 of the paretic leg 104. For example, the shank sensor 136 may generate or collect data related to the shank portion 110, the data comprising one or more of acceleration data indicating an acceleration for the shank portion 110, velocity data (e.g., angular velocity data) indicating a velocity or angular velocity for the shank portion 110, orientation data indicating an orientation of the shank portion 110, and/or position data indicating a position of the shank portion 110 (e.g., position of the shank portion 110 with respect to the thigh portion 108 of the paretic leg 104 or the position of the shank portion 110 with respect to the foot 112 of the paretic leg 104). For example, the shank sensor 136 may collect data related to the muscle activity along the shank portion 110 of the paretic leg 104. The muscle activity data may indicate a muscle activity level for the shank portion 108. The muscle activity level may be compared to a second muscle activity threshold. If the muscle activity level satisfies (e.g., is greater than or greater than or equal to) the second muscle activity threshold the muscle activity level may indicate an initiation of a phase of the gate cycle and/or a transition from one phase to another phase of the gait cycle.

For example, the orientation data may indicate an angle of orientation of the shank portion 110 as taken along an elongated axis (B) of the shank portion 110 as compared to a vertical axis or a horizontal axis. The shank sensor 136 may be electrically coupled to the power source. The shank sensor 136 may be communicably coupled to the control computing device 144 and/or the user device 148 and may send one or more of the acceleration data, velocity data (e.g., angular velocity data), orientation data, muscle activity data, and/or position data to the control computing device 144 and/or the user device 148.

The brace 120 may comprise a heel-strike sensor 138. The heel-strike sensor 138 may be positioned along a portion of the foot support section 126 of the brace 120 or along any other portion of the paretic leg 104. For example, the heel-strike sensor may be included as part of one of the other sensors 134, 136. For example, the heel-strike sensor 138 may be coupled to the bottom end or bottom surface of the foot support section 126. For example, the heel-strike sensor 138 may be an inertial measurement unit, a contact sensor, a pressure sensor, or another form of sensor. For example, the heel-strike sensor 138 may indicate when the foot support section 126, the heel of the foot 112 or another portion of the foot 112 of the paretic leg 104 contacts a floor surface. The heel-strike sensor 138 may be electrically coupled to the power source. The heel-strike sensor 138 may be communicably coupled to the control computing device 144 and/or the user device 148 and may send the data indicating the contact by the foot 112 or foot support section 126 with the floor surface to the control computing device 144 and/or the user device 148.

The brace 120 may comprise a foot sensor 140. The foot sensor 140 may be positioned along a portion of the foot 118, ankle, shank section 116, or any other portion of the non-paretic leg 106. For example, the foot sensor 140 may be an inertial measurement unit or another form of sensor. For example, the foot sensor 140 may comprise multiple sensors for detecting certain data related to the non-paretic leg 106. For example, the foot sensor 140 may generate or collect data related to the foot 118, shank portion 116, or another portion of the non-paretic leg 106, the data comprising one or more of acceleration data indicating an acceleration for the foot 118 or shank portion 116, velocity data (e.g., angular velocity data) indicating a velocity or angular velocity for the foot 118 or shank portion 116 (or another portion), orientation data indicating an orientation of the foot 118 or shank portion 116, heel-strike or contact information for the foot 118 along the floor surface and/or position data indicating a position of the foot 118 or shank portion 116. The foot sensor 140 may be electrically coupled to the power source. The foot sensor 140 may be communicably coupled to the control computing device 144 and/or the user device 148 and may send one or more of the acceleration data, velocity data (e.g., angular velocity data), orientation data, heel-strike or contact data, and/or position data to the control computing device 144 and/or the user device 148. Additional sensors (not shown) may be positioned along other portions of the non-paretic leg 106 similar to those described with regard to the paretic leg 104.

The brace 120 may comprise a hip or pelvic (“hip”) sensor. The hip sensor may be positioned along the hip or pelvic region of the user 102. For example, the hip sensor may comprise multiple sensors for detecting certain data related to the hip or pelvic region of the paretic leg 104. For example, the hip sensor may generate or collect data related to the hip or pelvic region, the data comprising one or more of acceleration data indicating an acceleration for the hip region, velocity data (e.g., angular velocity data) indicating a velocity or angular velocity for the hip region, orientation data indicating an orientation of the hip region, and/or position data indicating a position of the hip region. For example, the hip sensor may collect data related to the muscle activity along the hip or pelvic region of the paretic leg 104. The muscle activity data may indicate a muscle activity level for the hip or pelvic region. The muscle activity level may be compared to a third muscle activity threshold. If the muscle activity level satisfies (e.g., is greater than or greater than or equal to) the third muscle activity threshold the muscle activity level may indicate an initiation of a phase of the gate cycle and/or a transition from one phase to another phase of the gait cycle.

The system 100 may comprise a heel-strike sensor 142. The heel-strike sensor 142 may be positioned along a portion of a shoe or foot covering of the foot 118 of the non-paretic leg 106. For example, the heel-strike sensor 142 may be coupled to the bottom end or bottom surface of a shoe. For example, the heel-strike sensor 142 may be an inertial measurement unit, a contact sensor, a pressure sensor, or another form of sensor. For example, the heel-strike sensor 142 may indicate when the heel of the foot 118 or another portion of the foot 118 or shoe of the non-paretic leg 106 contacts the floor surface. The heel-strike sensor 142 may be electrically coupled to the power source. The heel-strike sensor 142 may be communicably coupled to the control computing device 144 and/or the user device 148 and may send the data indicating the contact with the floor surface to the control computing device 144 and/or the user device 148.

The system 100 may comprise a control computing device 144. The control computing device 144 may be a form of computer. The control computing device 144 may be communicably coupled to the sensors 129, 134-142, 154, 156, the motors 128, 152, and/or the electrodes 130A-B, 132. The control computing device 144 may communicate with the sensors 129, 134-142, 154, 156, the motors 128, 152, and/or the electrodes 130A-B, 132 via wired or wireless communication. For example, the control computing device 144 may communicate wirelessly via one or more of WI-FI, Bluetooth, Bluetooth Low Energy (BLE), Zigbee, or any other known wireless protocol with the sensors 129, 134-142, 154, 156, the motors 128, 152, and/or the electrodes 130A-B, 132. For example, the control computing device 144 may communicate wirelessly with the brace 120 either directly (e.g., via Bluetooth, BLE, Zigbee, etc.) or via a network (e.g., a WI-FI network), such as via the network device 146 or another network.

The control computing device 144 may comprise one or more processors, one or more memory modules, a power source, a communications module, and/or one or more selection buttons or switches. For example, the one or more processors may comprise any one or more of microcontrollers, microprocessors, or embedded processors. The one or more processers may be configured to receive the data from the one or more sensors 129, 134-142, 154, 156 and determine whether to initiate, terminate, adjust, and/or continue providing one or more of electrical stimuli or motorized assistance at the brace 120. For example, the power source may be a battery, such as a rechargeable battery. For example, the communications module may comprise a transmitter, receiver, or transceiver. The communications module may be configured to receive data from one or more of the sensors 129, 134-142, 154, 156. The communications module may be further configured to send instructions to one or more of the motors 128, 152 and/or the electrodes 130A-B, 132 to provide motorized assistance and/or electrical stimuli to the paretic leg 104.

The system 100 may comprise a user device 148. The user device 148 may be a form of computer (e.g., a computing device). The user device 148 may comprise a desktop computer, a laptop computer, a smart device, a mobile device (e.g., a mobile phone (e.g., a smart phone), a tablet device, a smart watch, etc.), and/or the like. The user device 148 may comprise one or more processors, one or more memory modules, a power source, a communications module, and/or one or more selection buttons or switches. For example, the one or more processors may comprises any one or more of microcontrollers, microprocessors, or embedded processors. The one or more processers may be configured to receive, either directly or indirectly via the control computing device 144, the data from the one or more sensors 129, 134-142, 154, 156 and determine whether to initiate, terminate, adjust, and/or continue providing one or more of electrical stimuli or motorized assistance at the brace 120. For example, the power source may be a battery, such as a rechargeable battery. For example, the communications module may comprise a transmitter, receiver, or transceiver. The communications module may be configured to receive data from one or more of the sensors 129, 134-142, 154, 156. The communications module may be further configured to send instructions to one or more of the motors 128, 152 and/or the electrodes 130A-B, 132, either directly or indirectly via the control computing device 144, to provide motorized assistance and/or electrical stimuli to the paretic leg 104. The control computing device 144 and the user device 148 may communicate via the network device 146.

The system 100 may comprise the network device 146. The network device 146 may comprise a local gateway (e.g., router, modem, switch, hub, combinations thereof, and the like) configured to connect (or facilitate a connection (e.g., a communication session) between) a local area network (e.g., a LAN) to a wide area network (e.g., a WAN). The network device 146 may be configured to receive incoming data (e.g., data packets or other signals) from the brace 120 (e.g., one or more of the sensors 129, 134-142, 154, 156) and route the data to the control computing device 144 and/or the user device 148. The network device 146 may be configured to receive incoming data from the control computing device 144 and/or the user device 148 and route that data to the brace 120 (e.g., one or more of the motors 128, 152 and/or electrodes 130A-B, 132). The network device 146 may be configured to communicate with a network. The network device 146 may be configured for communication with the network via a variety of protocols, such as IP, transmission control protocol, file transfer protocol, session initiation protocol, voice over IP (e.g., VoIP), combinations thereof, and the like. The network device 146 may be configured to facilitate network access via a variety of communication protocols and standards.

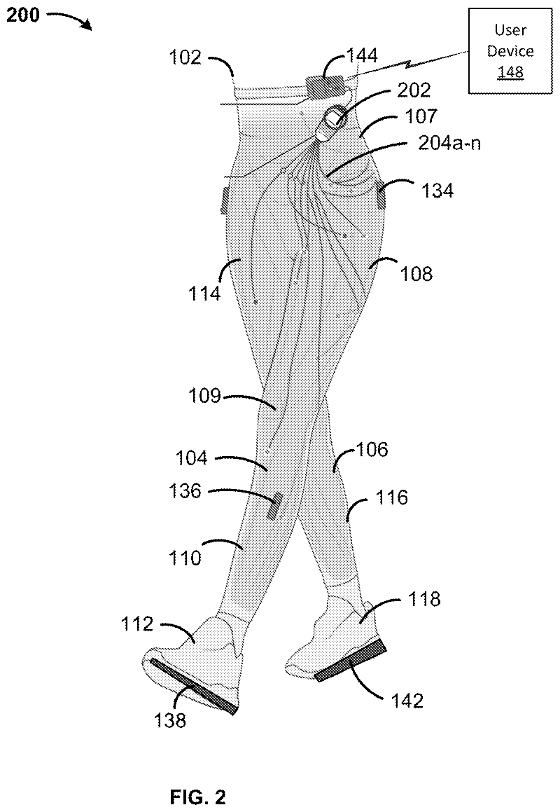

FIG. 2 shows an example system 200 for providing, terminating, or modifying assistance for leg movement. For example, the assistance may be provided to the user 102. While some elements may not be specifically shown, the system 200 of FIG. 2 may comprise the paretic leg 104, non-paretic leg 106, sensors 129, 134-142, 154, 156, user device 148, control computing device 144, and network device 146 as described in FIG. 1. The system 200 may further comprise a pulse generator 202. The pulse generator 202 may be configured to generate electrical pulses (stimuli) for one or more electrodes 204a-n. All or a portion of the pulse generator 202 may be implanted under the skin of the user 102. For example, the pulse generator 202 may be implanted in the thigh portion 108 of the paretic leg 106. In other examples, the pulse generator 202 may be implanted in another portion of the body of the user 102. For example, the pulse generator 202 may be communicably coupled to the control computing device 144 via wired or wireless communication. For example, the pulse generator 202 may be communicably coupled to the user device 148 via wireless communication. For example, the pulse generator 202 may be electrically coupled to one or more electrodes 204a-n. Each of the one or more electrodes 204a-n may be implanted within a portion of the legs (e.g., the paretic leg 104 and/or the non-paretic leg 106) of the user 102 to provide electrical stimuli to the muscles of the user 102 and/or monitor the activity of the paretic leg 104 and/or non-paretic leg 106 of the user 102.

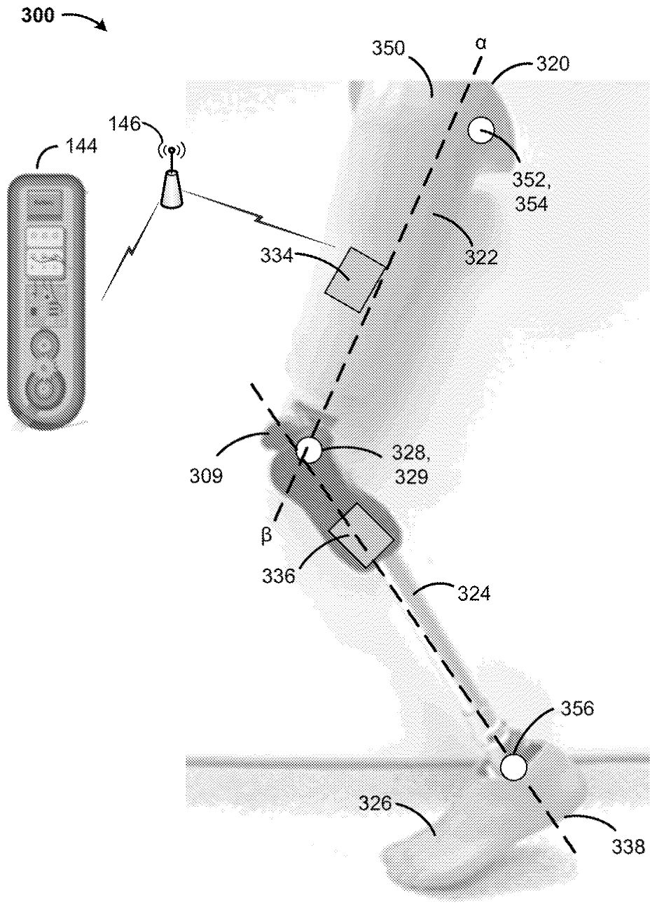

FIG. 3 shows an example system 300 for providing assistance for movement of a prosthetic leg. For example, the assistance may be provided to a user, such as a person. For example, the user may be substantially similar to the user 102 except that the user may have had all or a portion of their leg amputated. For example, the user may further have another leg, substantially the same as the non-paretic leg of 106 of FIG. 1 and the system 300 may include the same sensors as described herein with regard to the non-paretic leg 106 on the other leg of the user.

The amputated leg may comprise a pelvic (or hip) portion and, in certain examples, a partial thigh portion. The other leg of the user may comprise a thigh portion, a shank portion, and a foot. For example, the thigh portion may be the portion of the other leg between the hip and the knee of the other leg. For example, the shank portion may be the portion of the other leg between the knee and the foot of the other leg of the user.

The system 300 may comprise a prosthetic leg 320. For example, the prosthetic leg 320 may be configured to be attached to the remaining portion of the amputated leg of the user. The prosthetic leg 320 may be made of one or more of plastic or metal components. For example, the prosthetic leg 320 may comprise one or more straps, belts, or the like for removably attaching the prosthetic leg 320 to the remaining portion of the amputated leg of the user. For example, the one or more straps may comprise hook and loop straps that provide adjustability in attaching the prosthetic leg 320 to the remaining portion of the leg of the user.

The prosthetic leg 320 may comprise one or more sections. For example, the prosthetic leg 320 may comprise a thigh section 322, a shank section 324, and a foot section 326. In certain examples, the prosthetic leg 320 may also comprise a hip section 350. The thigh section 322 may be movably coupled to the shank section 324 at a knee joint 309 and may be configured to move or rotate with respect to the shank section 324. In certain examples, the thigh section 322 may also be movably coupled to the hip section 350 and may be configured to move or rotate with respect to the hip section 350. The thigh section 322 may include an elongated cavity for receiving the remaining portion of the amputated leg. The thigh section 322 may comprise one or more straps, belts, or the like for removably attaching the thigh section 322 to the remaining portion of the amputated leg. For example, the one or more straps may comprise hook and loop straps that provide adjustability in attaching the thigh section 322 to the remaining portion of the amputated leg.

The shank section 324 may be movably coupled to the thigh section 322 and may be configured to move or rotate with respect to the thigh section 322 about the knee joint 309. The shank section 324 may be movably coupled to the foot section 326 and may be configured to move or rotate with respect to the foot section 326. The shank section 324 may include an elongated support member.

The foot section 326 may be movably coupled to the shank section 324 and may be configured to move or rotate with respect to the shank section 324. The foot section 326 may include one or more panels.

£ The hip section 350, if optionally included, may be movably coupled to the thigh section 322 and may be configured to move or rotate with respect to the thigh section 322. The hip section 350 may extend above and/or horizontally out from the thigh section 322. The hip section 350 may include a support member (e.g., an elongated support member). The support member may be configured to extend along at least a portion of the pelvic portion of the remaining portion of the amputated leg of the user.

The prosthetic leg 320 may comprise one or more motors 328. The one or more motors 328 may be positioned at or near an axis of rotation between the thigh section 322 and the shank section 324, such as along the knee portion 309. In certain examples, another one or more motors 352 may be positioned at or near an axis of rotation between the thigh section 322 and the hip section 350. For example, the one or more motors 352 may be provided for users that have limited active hip or thigh motion. The one or more motors 328 may be configured to provide motorized assistance for the shank section 324 to rotate with respect to the thigh section 322 of the prosthetic leg 320. The one or more motors 352 may be configured to provide motorized assistance for the thigh section 322 to rotate with respect to the hip section 350 of the brace prosthetic leg 320. For example, the one or more motors 352 may provide motorized assistance with hip flexion at the end of the terminal stance phase and then during early, mid, and terminal swing. Motorized assistance may reduce during terminal swing and the one or more motors 352 may provide motorized assistance with hip/thigh extension from heel strike to midstance. In other examples, the one or more motors 352 may be configured to provide motorized resistance with respect to the remaining portion of the thigh portion of the user rotating with respect to the pelvic portion of the user by providing motorized resistance against the thigh section 322 rotating with respect to the hip section 350 of the prosthetic leg 320.

The one or more motors 328 may include or be operably coupled to a sensor 329. For example the sensor 329 may be an encoder. The sensor may provide rotational data indicating the amount of rotation of the shank section 324 with respect to the thigh section 322. The one or more motors 328 and the sensor 329 may be electrically coupled to a power source (not shown). The one or more motors 352 may include or be operably coupled to a sensor 354. For example, the sensor 354 may be an encoder. The sensor 354 may provide rotational data indicating the amount of rotation of the thigh section 322 with respect to the hip section 350 of the prosthetic leg 320. The one or more motors 352 and the sensor 354 may be electrically coupled to a power source (not shown). The prosthetic leg 320 may further comprise a sensor 356. For example, the sensor 356 may be an encoder. The sensor 356 may provide rotational data indicating the amount of rotation of the foot section 326 with respect to the shank section 324 of the prosthetic leg 320. The sensor 356 may be electrically coupled to a power source (not shown). The power source may be coupled to the prosthetic leg 320 and may be configured to provide electrical power to one or more components of the prosthetic leg 320. For example, the power source may be a battery or battery pack, such as a rechargeable battery. For example, the power source may be one or more of a lead-acid rechargeable battery, a nickel-cadmium rechargeable battery, a nickel-metal hydride rechargeable battery, or a lithium-ion rechargeable battery.

The brace 120 may comprise one or more electrodes. The one or more electrodes may be electrically coupled to a pulse generator (not shown but similar to the pulse generator of FIG. 2) that provides an electrical pulse to the electrodes. The one or more electrodes may be positioned at one or more locations along the remaining portion of the thigh of the amputated leg. The one or more electrodes may be configured to provide electrical stimuli to the muscles of the remainder of the thigh portion of the amputated leg in order to provide assistance with rotation and/or movement of the thigh. The one or more electrodes may be operably coupled to the sensor 356, the sensor 329 for the motor 328 and/or the sensor 354. The sensor 329 for the motor 328 may provide rotational data indicating the amount of rotation of the shank section 324 with respect to the thigh section 322. The sensor 354 may provide rotational data indicating the amount of rotation of the thigh section 322 with respect to the hip section 350. The one or more electrodes may be electrically coupled to the power source.

The prosthetic leg 320 may comprise a thigh sensor 334. The thigh sensor 334 may be positioned along a portion of the thigh section 322 of the prosthetic leg 320. For example, the thigh sensor 334 may be coupled to the elongated member of the thigh section 322. For example, the thigh sensor 334 may be an inertial measurement unit or another form of sensor. For example, the thigh sensor 334 may comprise multiple sensors for detecting certain data related to the movement of the thigh section 322. For example, the thigh sensor may generate or collect data related to the thigh section 322, the data comprising one or more of acceleration data indicating an acceleration for the thigh section 322, angular velocity data indicating an angular velocity for the thigh section 322, orientation data indicating an orientation of the thigh section 322, and/or position data indicating a position of the thigh section 322. For example, the thigh sensor 334 may collect data related to the muscle activity along the remaining portion of the thigh of the amputated leg. The muscle activity data may indicate a muscle activity level for the remaining portion of the thigh of the amputated leg. The muscle activity level may be compared to a muscle activity threshold. If the muscle activity level satisfies (e.g., is greater than or greater than or equal to) the muscle activity threshold the muscle activity level may indicate an initiation of a phase of the gate cycle and/or a transition from one phase to another phase of the gait cycle.

For example, the orientation data may indicate the an angle of the thigh section 322 as taken along an elongated axis (a) of the thigh section 322 as compared to a vertical axis or a horizontal axis. The thigh sensor 334 may be electrically coupled to the power source. The thigh sensor 334 may be communicably coupled to the control computing device 144 and may send the one or more of the acceleration data, velocity data (e.g., angular velocity data), orientation data, muscle activity data, and position data to the control computing device 144.

The prosthetic leg 320 may comprise a shank sensor 336. The shank sensor 336 may be positioned along a portion of the shank section 324 of the prosthetic leg 320. For example, the shank sensor 336 may be coupled to the elongated member of the shank section 324. For example, the shank sensor 336 may be an inertial measurement unit or another form of sensor. For example, the shank sensor 336 may comprise multiple sensors for detecting certain data related to the shank section 324. For example, the shank sensor 336 may generate or collect data related to the shank section 324, the data comprising one or more of acceleration data indicating an acceleration for the shank section 324, velocity data indicating an angular velocity for the shank section 324, orientation data indicating an orientation of the shank section 324, and/or position data indicating a position of the shank section 324.

For example, the orientation data may indicate the an angle of the shank section 324 as taken along an elongated axis (B) of the shank section 324 as compared to a vertical axis or a horizontal axis. The shank sensor 336 may be electrically coupled to the power source. The shank sensor 336 may be communicably coupled to the control computing device 144 and may send the one or more of the acceleration data, velocity data, orientation data, muscle activity data, and/or position data to the control computing device 144.

The prosthetic leg 320 may comprise a heel-strike sensor 338. The heel-strike sensor 338 may be positioned along a portion of the foot section 326 of the prosthetic leg 320. For example, the heel-strike sensor 338 may be coupled to the bottom end or bottom surface of the foot section 326. For example, the heel-strike sensor 338 may be an inertial measurement unit, a contact sensor, a pressure sensor, or another form of sensor. For example, the heel-strike sensor 338 may indicate when the foot section 326, the heel of the foot section 326 or another portion of the foot section 326 contacts a floor surface. The heel-strike sensor 338 may be electrically coupled to the power source. The heel-strike sensor 338 may be communicably coupled to the control computing device 144 and may send the data indicating the contact with the floor surface to the control computing device 144.

The system 300 may comprise a foot sensor substantially the same as the foot sensor 140 of FIG. 1. The foot sensor may be positioned along a portion of the foot, ankle, shank section, or another portion of the other leg of the user. For example, the foot sensor may be an inertial measurement unit or another form of sensor. For example, the foot sensor may comprise multiple sensors for detecting certain data related to the other leg of the user. For example, the foot sensor may generate or collect data related to the foot or shank portion of the other leg of the user, the data comprising one or more of acceleration data indicating an acceleration for the foot or shank portion, velocity data indicating an angular velocity for the foot or shank portion, orientation data indicating an orientation of the foot or shank portion, heel-strike or contact information for the foot along the floor surface and/or position data indicating a position of the foot or shank portion. The foot sensor may be electrically coupled to the power source. The foot sensor may be communicably coupled to the control computing device 144 and may send the one or more of the acceleration data, angular velocity data, orientation data, heel-strike contact data, muscle activity data, and/or position data to the control computing device 144.

The system 300 may comprise a heel-strike sensor substantially the same as the heel-strike sensor 142 of FIG. 1. The heel-strike sensor may be positioned along a portion of a shoe or foot covering of the foot of the other leg of the user. For example, the heel-strike sensor may be coupled to the bottom end or bottom surface of a shoe. For example, the heel-strike sensor may be an inertial measurement unit, a contact sensor, a pressure sensor, or another form of sensor. For example, the heel-strike sensor may indicate when the heel of the foot or another portion of the foot or shoe of the other leg of the user contacts the floor surface. The heel-strike sensor may be electrically coupled to the power source. The heel-strike sensor may be communicably coupled to the control computing device 144 and may send the data indicating the contact with the floor surface to the control computing device 144.

The system 300 may comprise a control computing device 144. The control computing device 144 may be a form of computer. The control computing device 144 may be communicably coupled to the sensors 329, 334-338, 354, 356, the motors 328, 352, and/or the electrodes. The control computing device 144 may communicate with the sensors 329, 334-338, 354, 356, the motors 328, 352, and/or the electrodes via wired or wireless communication. For example, the control computing device 144 may communicate wirelessly via one or more of WI-FI, Bluetooth, Bluetooth Low Energy (BLE), Zigbee, or any other known wireless protocol with the sensors 329, 334-338, 354, 356, the motors 328, 352, and the electrodes. For example, the control computing device 144 may communicate wirelessly with the prosthetic leg 320 either directly (e.g., via Bluetooth, BLE, Zigbee, etc.) or via a network (e.g., a WI-FI network), such as via the network device 146 or another network. For example, the control computing device 144 may be a user device, such as a desktop computer, a laptop computer, a smart device, a mobile device (e.g., a mobile phone (e.g., a smart phone), a tablet device, a smart watch, etc.), and/or the like.

The control computing device 144 may comprise one or more processors, one or more memory modules, a power source, a communications module, and/or one or more selection buttons or switches. For example, the one or more processors may comprise any one or more of microcontrollers, microprocessors, or embedded processors. The one or more processers may be configured to receive the data from the one or more sensors 329, 334-338, 354, 356 and determine whether to initiate, terminate, reduce, and/or continue providing one or more of electrical stimuli or motorized assistance at the prosthetic leg 320. For example, the power source may be a battery, such as a rechargeable battery. For example, the communications module may comprise a transmitter, receiver, or transceiver. The communications module may be configured to receive data from one or more of the sensors 329, 334-338, 354, 356. The communications module may be further configured to send instructions to the motors 328, 352 and/or the electrodes to provide motorized assistance to the prosthetic leg 320 and/or electrical stimuli to the remaining portion of the thigh of the amputated leg.

The system 300 may comprise the network device 146. The network device 146 may comprise a local gateway (e.g., router, modem, switch, hub, combinations thereof, and the like) configured to connect (or facilitate a connection (e.g., a communication session) between) a local area network (e.g., a LAN) to a wide area network (e.g., a WAN). The network device 146 may configured to receive incoming data (e.g., data packets or other signals) from the prosthetic leg 320 (e.g., one or more of the sensors 329, 334-338, 354, 356,) and route the data to the control computing device 144 and may be configured to receive incoming data from the control computing device 144 and route that data to the prosthetic leg 320 (e.g., one or more of the motors 328, 352 and/or electrodes). The network device 146 may be configured to communicate with a network. The network device 146 may be configured for communication with the network via a variety of protocols, such as IP, transmission control protocol, file transfer protocol, session initiation protocol, voice-over IP (e.g., VoIP), combinations thereof, and the like. The network device 146 may be configured to facilitate network access via a variety of communication protocols and standards.

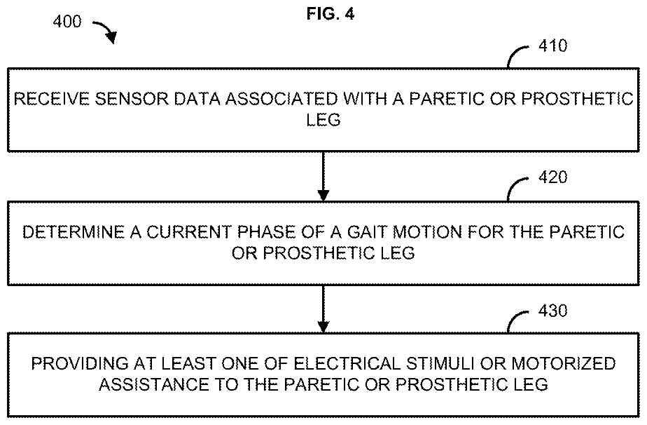

FIG. 4 shows an example method 400 for providing motorized assistance or electrical stimuli for leg movement. Referring to FIGS. 1-4, the method 400 may be completed by one or more of the control computing device 144, the user device 148, the brace 120 (or the prosthetic leg 320), and/or the pulse generator 202. The method 400 may use sensor data to evaluate the current activity of the user 102 (e.g., walking, standing, transitioning between walking and standing) and determine what, if any, motorized assistance and/or electrical stimuli to provide to the paretic leg 104 (or the prosthetic leg 320) of the user 102. For example, the method 400 may determine which phase of a gait cycle the paretic leg 104 (or the prosthetic leg 320) is currently in and determine, based on that phase, what and how much motorized assistance and/or electrical stimuli to provide to the paretic leg 104 (or the prosthetic leg 320).

At 410, sensor data may be received. For example, the sensor data may be associated with the paretic leg 104 (or the prosthetic leg 320). For example, the sensor data may be received from one or more sensors (e.g., the sensors 129, 134-142, 154, 156 or 329, 334-338, 354, 356,) located on and/or receiving data about the paretic leg 104 (or the prosthetic leg 320). For example, the sensor data may be received by a computing device, such as the control computing device 144 and/or the user device 148, from one or more of the sensors 129, 134-142, 154, 156 or 329, 334-338, 354, 356. The sensor data may be received at a first time. For example, the sensor data may comprise one or more of velocity data (e.g., angular velocity data) for of all or a portion of the paretic leg 104 (or the prosthetic leg 320), acceleration data of all or a portion of the paretic leg 104 (or the prosthetic leg 320), orientation data of all or a portion of the paretic leg 104 (or the prosthetic leg 320), position data for all or a portion of the paretic leg 104 (or the prosthetic leg 320), muscle activity data for all or a portion of the paretic leg 104 (or the remaining portion of the thigh of the amputated leg), or rotational relation data for one portion with respect to another portion of the paretic leg 104 (or the prosthetic leg 320). For example, the sensor data may comprise a calculated estimated center of mass of the body of the user 102. For example, the portion of the paretic leg 104 (or the prosthetic leg 320) may comprise one of the thigh portion 108 of the paretic leg 104 (or the thigh section 322 of the prosthetic leg 320), the shank portion 110 of the paretic leg 104 (or the shank portion 324 of the prosthetic leg 320), or the foot 112 of the paretic leg (or foot section 326 of the prosthetic leg 320).

For example, the sensor data may comprise one or more of an orientation (e.g., an angle of orientation) for the thigh portion 108 of the paretic leg 104 (or the thigh section 322 of the prosthetic leg 320), an acceleration of the thigh portion 108 (or the thigh section 322), an angular velocity of the thigh portion 108 (or the thigh section 322), a position of the thigh portion 108 (or the thigh section 322), muscle activity data for the thigh portion 108 (or the remaining portion of the thigh of the amputated leg), or rotational relation data of the thigh portion 108 (or the thigh section 322) with respect to the shank portion 110 (or the shank portion 324). For example, the angle of orientation for the thigh portion 108 (or the thigh section 322) may be determined based on the angle between the longitudinal axis α of the thigh portion 108 (or the thigh section 322) and one of a vertical axis and a horizontal axis. For example, the sensor data may comprise one or more of an orientation (e.g., an angle of orientation) for the shank portion 110 of the paretic leg 104 (or the shank portion 324 of the prosthetic leg 320), an acceleration of the shank portion 110 (or the shank portion 324), an angular velocity of the shank portion 110 (or the shank portion 324), a position of the shank portion 110 (or the shank portion 324), muscle activity data for the shank portion 110, or rotational relation data of the shank portion 110 (or the shank portion 324) with respect to the foot 112 (or the foot section 326). For example, the angle of orientation for the shank portion 110 (or the shank portion 324) may be determined based on the angle between the longitudinal axis β of the shank portion 110 (or the shank portion 324) and one of a vertical axis and a horizontal axis. For example, the sensor data may comprise heel-strike or foot-floor contact data for the paretic leg 104 (or the prosthetic leg 320).

For example, the computing device, such as the control computing device 144 or the user device 148, may receive second sensor data. For example, the second sensor data may be received from one or more of the sensors 140, 142, 206 or any other sensors or encoders coupled to or associated with the non-paretic leg 106 of the user 102. For example, the second sensor data may comprise orientation data, acceleration data, velocity data (e.g., angular velocity data), position data, heel strike data, encoder data, muscle activity data, and/or foot-floor contact data for all or similar portions of the non-paretic leg 106.

At 420, a current phase of the gait motion for the paretic leg 104 (or the prosthetic leg 320) may be determined. The current phase of the gait motion may be determined by the user device 148, the control computing device 144 or any other computing device. For example, the current phase of the gait motion may be determined based on the received sensor data for the paretic leg 104 (or the prosthetic leg 320) and/or the calculated estimate of the center of mass of the body of the user 102. For example, the current phase of the gait motion of the paretic leg 104 (or the prosthetic leg 320) may be determined based on an orientation of the thigh portion 108 of the paretic leg 104 (or the thigh section 322 of the prosthetic leg 320) and an angular velocity of the thigh portion 108 (or the thigh section 322). For example, the current phase of the gait motion may be determined based on the orientation of the thigh portion 108 (or the thigh section 322) and the orientation of the shank portion 110 of the paretic leg 104 (or the shank portion 324 of the prosthetic leg 320). For example, the current phase of the gait motion may be determined based on the heel-strike or pressure data from the sensor that detects heel-strike 138, 338. For example, the current phase of the gait motion may be determined based on the heel-strike or pressure data from the sensor that detects heel-strike 138, 338, the orientation, angular velocity, muscle activity, and/or position data for the thigh portion 108 (or the thigh section 322) from the thigh sensor 134, 334, and/or the orientation, angular velocity, muscle activity, and/or position data for the shank portion 110 (or the shank portion 324) from the shank sensor 136, 336. For example, the current phase of the gait motion of the paretic leg 104 (or the prosthetic leg 320) may further be determined based on the velocity data (e.g., angular velocity data) for the shank portion 110 of the paretic leg 104 (or the shank portion 324 of the prosthetic leg 320). For example, the current phase of the gait motion of the paretic leg 104 (or the prosthetic leg 320) may further be determined based on all or any portion of the second sensor data associated with the non-paretic leg 106 of the user 102. For example, the current phase of the gait motion of the paretic leg 104 (or the prosthetic leg 320) may further be determined based on the calculated estimate of the center of mass of the body of the user 102.

For example, initial swing phase of the swing phase may be determined based on the sensors on the thigh portion 108 (or the thigh section 322) and the shank portion 110 (or the shank portion 324) (e.g., orientation data and/or velocity (angular velocity) for those portions) of the paretic leg 104 (or the prosthetic leg 320). For example, the initial phase of the gait motion of the paretic leg 104 (or the prosthetic leg 320) may further be determined based on the calculated estimate of the center of mass of the body of the user 102. For example, a transition from the initial swing phase to midswing and/or terminal swing may be determined based on the orientation (e.g., angle of orientation) and velocity (e.g., angular velocity) of the thigh portion 108 (or the thigh section 322) as compared to a threshold (e.g., satisfying the threshold or not satisfying the threshold). For example, the transition from the initial swing phase to midswing and/or terminal swing phase of the gait motion of the paretic leg 104 (or the prosthetic leg 320) may further be determined based on the calculated estimate of the center of mass of the body of the user 102. For example, the transition to early stance phase (e.g., heel-strike) may be determined based on heel-strike data for the paretic leg 104 (or the prosthetic leg 320). For example, the transition to early stance phase of the gait motion of the paretic leg 104 (or the prosthetic leg 320) may further be determined based on the calculated estimate of the center of mass of the body of the user 102. Determining heel-strike may be determined from data of any one of the thigh sensor 134, 334, the shank sensor 136, 336, or the sensor 138, 338 (such as a foot sensor or foot-floor contact sensor). For example, determining the paretic leg 104 (or the prosthetic leg 320) is transitioning from the heel-strike portion of the stance phase to midstance of the stance phase may be based on an angle of orientation of the shank portion 110 (or the shank portion 324) and/or thigh portion 108 (or the thigh section 322) and/or a velocity (e.g., angular velocity) of the thigh portion 108 and/or shank portion 110 (or the shank portion 324). For example, the angle or orientation and angular velocity of the thigh portion 108 (or the thigh section 322) and/or the shank portion 110 (or the shank portion 324) may be compared to a threshold to determine the transition. For example, determining the paretic leg 104 (or the prosthetic leg 320) is transitioning from the heel-strike portion of the stance phase to midstance of the stance phase may be based on the leg progression equation:

(atan((sin(t1)-sin(t2))/(cos(t1)+cos(t2)));

where (t1) represents the thigh orientation relative to gravity with respect to the hip and (t2) represents the shank orientation relative to gravity with respect to the ankle of the paretic leg 104 (or the prosthetic leg 320). For example, the transition from heel-strike to midstance of the stance phase of the gait motion of the paretic leg 104 (or the prosthetic leg 320) may further be determined based on the calculated estimate of the center of mass of the body of the user 102. For example, determining the paretic leg 104 (or the prosthetic leg 320) is in the midstance to toe-off portions of the stance phase may be further based on the angular velocity for one or more of the shank portion 110 (or the shank portion 324) or thigh portion 108 (or the thigh section 322). For example, the transition from midstance to toe-off of the stance phase of the gait motion of the paretic leg 104 (or the prosthetic leg 320) may further be determined based on the calculated estimate of the center of mass of the body of the user 102.

For example, the current phase of the gait motion for the paretic leg 104 (or the prosthetic leg 320) may be one of stance phase (e.g., heel-strike, foot flat, midstance, heel off, toe off) or swing phase (e.g., initial swing, mid-swing, or terminal swing).

At 430, at least one of electrical stimuli or motorized assistance may be provided to the paretic leg 104 (or the prosthetic leg 320). For example, the user device 148, the control computing device 144, or another computing device may cause the electrical stimuli and/or the motorized assistance to be provided to the paretic leg 104 (or the prosthetic leg 320). For example, the user device 148 or the control computing device 144 may send a signal to one or more of the motors 128, 152 or 328, 352 (e.g., via the network device 146) to provide motorized assistance and/or to the electrodes 130A-B, 132, 204a-n or the pulse generator 202 to provide electrical stimuli to the paretic leg 104 (or the prosthetic leg 320). The electrical stimuli and/or motorized assistance may be provided based on the current phase of the gait motion of the paretic leg 104 (or the prosthetic leg 320).

For example, the motorized assistance may be provided by providing the motorized assistance via the neuroprosthesis, exoskeleton, or brace 120 coupled to the paretic leg 104, or a prosthetic leg 320). For example, the motor 128, 328 of the brace 120 (or the prosthetic leg 320) may provide motorized assistance by causing the shank section 124 of the brace 120 (or the shank portion 324 of the prosthetic leg 320) to rotate with respect to the thigh section 122 of the brace 120 (or the thigh section 322 of the prosthetic leg 320). For example, the motor 152, 352 of the brace 120 (or the prosthetic leg 320) may provide motorized assistance by causing the thigh section 122 of the brace 120 (or the thigh section 322 of the prosthetic leg 320) to rotate with respect to the hip section 150 of the brace 120 (or hip section 350 of the prosthetic leg 320). For example, the electrodes 130A-B, 132, 204a-n or the pulse generator 202 may provide electrical stimuli to portions of the paretic leg 104 (or the prosthetic leg 320) by sending electrical pulses into the muscles of the paretic leg 104 (or the prosthetic leg 320). Accordingly, electrical stimuli may be provided to all or one or more portions of the paretic leg 104 (or the prosthetic leg 320) by one or more of embedded electrodes 204a-n providing internal electrical stimuli or surface electrodes 130A-B, 132 providing external electrical stimulus. For example, the amount, location, and type of motorized assistance and/or electrical stimuli provided may vary based on the current phase of the gait motion, the position of the paretic leg 104 (or the prosthetic leg 320) within that current phase of the gait motion, and/or the calculated estimate of the center of mass of the body of the user 102.

For example, based on the sensor data for the paretic leg 104 (or the prosthetic leg 320), the second sensor data for the non-paretic leg 106, and/or the estimated center of mass for the body of the user 102, the user device 148 or the control computing device 144 may determine that the paretic leg 104 (or the prosthetic leg 320) is in a swing phase. For example, the swing phase may be one of an initial swing phase, a midswing phase, or a terminal swing phase. For example, the user device 144 or the control computing device 148, based on determining the paretic leg 104 (or the prosthetic leg 320) is in a swing phase, may send a signal to provide at least one of electrical stimuli or motorized assistance (e.g., via the brace 120 (or the prosthetic leg 320)) to all or at least a portion of the paretic leg 104 (or the prosthetic leg 320).

Based on the determination that the paretic leg 104 (or the prosthetic leg 320) is in the swing phase, the user device 148 or the control computing device 144 may receive additional sensor data. The additional sensor data may be associated with the paretic leg 104 (or the prosthetic leg 320). For example, the additional sensor data may also comprise the estimated center of mass for the body of the user 102. For example, the additional sensor data may be received at a second time that is subsequent to the first time that the sensor data was received. For example, the additional sensor data may comprise all or any portion of the forms of sensor data received at the first time. For example, the additional sensor data may comprise data associated with the paretic leg 104 (or the prosthetic leg 320) that was not included in the sensor data received at the first time. The additional sensor data may be received from any one or more of the sensors 129, 134-142, 154, 156 or 329, 334-338, 354, 356.

The user device 148 or the control computing device 144 may determine an error with at least a portion of a trajectory of the swing phase of the gait motion of the paretic leg 104 (or the prosthetic leg 320). For example, the trajectory may be determined based on one or more of all or a portion of the sensor data or all or a portion of the additional sensor data. For example, the error may be determined based on one or more of the trajectory of the swing phase for the paretic leg 104 (or the prosthetic leg 320) and/or all or a portion of the sensor data and/or the additional sensor data. For example, the user device 148 or the control computing device 144 may compare the trajectory (e.g., position, angular velocity, acceleration, rotational relation, muscle activity, and/or angle of orientation of the thigh 108, shank 110, and/or foot 112 portions) of the swing phase of the paretic leg 104 (or the thigh 322, shank 324, and/or foot 326 sections of the prosthetic leg 320) to an optimal trajectory of the swing phase (e.g., optimal angular velocity, optimal position, optimal acceleration, optimal rotational relation, and/or optimal angle of orientation). Based on a determination that the trajectory of the swing phase of the paretic leg 104 (or the prosthetic leg 320) does not match or is not within one or more predetermined trajectory or position thresholds for the swing phase, the user device 148 or control computing device 144 may determine that the paretic leg 104 (or the prosthetic leg 320) is not moving properly or efficiently through the swing phase. For example, the angular velocity of the thigh portion 108 (or the thigh section 322) may be compared to the optimal angular velocity for the thigh portion 108 (or the thigh section 322), the position of the thigh portion 108 (or the thigh section 322) may be compared to the optimal position for the thigh portion 108 (or the thigh section 322), the acceleration of the thigh portion 108 (or the thigh section 322) may be compared to the optimal acceleration for the thigh portion 108 (or the thigh section 322), the angle of orientation for the thigh portion 108 (or the thigh section 322) may be compared to the optimal angle of orientation for the thigh portion (or the thigh section 322). Similar analysis may be completed for the shank portion 110 (or the shank portion 324) and/or the foot 112 (or the foot section 326).

For example, the trajectory may be divided into a plurality of portions of the trajectory and the target trajectory may be similarly divided into a plurality of portions of a target trajectory. This allows for the determination of error along discreet portions of the trajectory. The plurality of portions of the trajectory may be determined based on one or more of all or a portion of the sensor data or all or a portion of the additional sensor data. For example, the error may be determined based on one or more of the trajectory (or plurality of portions thereof) of the swing phase for the paretic leg 104 (or the prosthetic leg 320) and/or all or a portion of the sensor data and/or the additional sensor data. For example, the user device 148 or the control computing device 144 may compare the trajectory (e.g., position, angular velocity, acceleration, rotational relation, muscle activity, and/or angle of orientation of the thigh 108, shank 110, and/or foot 112 portions) of each of a plurality of portions of the swing phase of the paretic leg 104 (or the thigh 322, shank 325, and/or foot 326 sections of the prosthetic leg 320) to an optimal or target trajectory of the corresponding plurality of portions of the swing phase (e.g., optimal angular velocity, optimal position, optimal acceleration, optimal rotational relation, and/or optimal angle of orientation). Based on a determination that the trajectory of the swing phase or one or more of the plurality of portions of the swing phase of the paretic leg 104 (or the prosthetic leg 320) does not match or is not within one or more predetermined trajectory or position thresholds for the swing phase (or that respective portion of the plurality of portions of the swing phase), the user device 148 or control computing device 144 may determine that the paretic leg 104 (or the prosthetic leg 320) is not moving properly or efficiently through all or particular portions of the plurality of portions of the swing phase. For example, the angular velocity of the thigh portion 108 (or the thigh section 322) may be compared to the optimal angular velocity for the thigh portion 108 (or the thigh section 322), the position of the thigh portion 108 (or the thigh section 322) may be compared to the optimal position for the thigh portion 108 (or the thigh section 322), the acceleration of the thigh portion 108 (or the thigh section 322) may be compared to the optimal acceleration for the thigh portion 108 (or the thigh section 322), the angle of orientation for the thigh portion 108 (or the thigh section 322) may be compared to the optimal angle of orientation for the thigh portion (or the thigh section 322) for the entire trajectory and/or for each of the plurality of portions of the trajectory for the swing phase. Similar analysis may be completed for the pelvic portion 107 (or hip section 350), the knee portion 109 (or the knee section 309), the shank portion 110 (or the shank section 324), and/or the foot 112 (or the foot section 326) for the entire trajectory and/or for each of the plurality of portions of the trajectory for the swing phase. In certain examples, the position, velocity, acceleration, and/or angular orientation of the pelvic portion 107 (or hip section 350) may be inferred from the data for the thigh portion 108 (or the thigh section 322) and the shank portion 110 (or the shank section 324).

In another example, trajectory may be determined as a function of the kinematics of one portion of the paretic leg 104 (or the prosthetic leg 320) with respect to one or more other portions of the paretic leg 104 (or the prosthetic leg 320). For example, the knee angle at a given orientation of the thigh portion 108 (or the thigh section 322) or shank portion 110 (or the shank section 324) during a plurality of portions of the swing phase may be evaluated to determine the trajectory and error in trajectory for the paretic leg 104 (or the prosthetic leg 320).

Based on the determination that there is an error and based on the amount of error or offset for the paretic leg 104 (or the prosthetic leg 320) or a portion thereof, the user device 148 or the control computing device 144 may determine which of the motorized assistance and/or the electrical stimuli to adjust and how much one or both should be adjusted. For example, the user device 148 or the control computing device 144 can compare the amount of error and the location and/or phase of the gait motion where the error was detected to a database of gait adjustment parameters in or accessible to the user device 148 and/or the control computing device 144 to determine whether to adjust one or both of the motorized assistance or the electrical stimuli and the amount and location (e.g. for electrical stimuli) for providing the adjustment.

The user device 148 or the control computing device 144 may modify at least one of the electrical stimuli or the motorized assistance provided to the paretic leg 104 (or the prosthetic leg 320) during the next swing phase for the paretic leg in order to attempt to correct the error. For example, the user device 148 or the control computing device 144 may send a signal to one or more of the motors 128, 152, or 328, 352, electrodes 130A-B, 132, 204a-n, and/or to the pulse generator 202 to indicate one or more adjusted settings or outputs for the motorized assistance and/or the electrical stimuli. The modification of at least one of the electrical stimuli or the motorized assistance may be based on the determined error. For example, the modification may be based on the analysis of the database of gait adjustment parameters and the amount of error detected.

Returning to the error determination, for example, determining the error with at least a portion of the trajectory of the swing phase of the gait motion may comprise the user device 148 or the control computing device 144 determining a time of a knee extension of the paretic leg (or the prosthetic leg 320) during the swing phase of the paretic leg. For example, the time of the knee extension may be determined based on the additional sensor data. The user device 148 or the control computing device 144 may determine a maximum elevation of a toe region of the foot 112 (or the foot section 326) during a time prior to the time of the swing phase of the paretic leg 104 (or the prosthetic leg 320). For example, the maximum elevation of the toe region may be determined based on the additional sensor data or previous sensor data received at a time prior to the first time of receiving the sensor data. For example, the maximum elevation of the toe region may be determined immediately prior to beginning the swing phase for the paretic leg 104 (or the prosthetic leg 320). The user device 148 or the control computing device 144 may determine a second maximum elevation of a toe region of the foot 112 (or the foot section 326) during a time after the time of the swing phase of the paretic leg 104 (or the prosthetic leg 320). For example, the second maximum elevation of the toe region may be determined based on the additional sensor data subsequently received at a time after to the first time of receiving the sensor data. For example, the second maximum elevation of the toe region may be determined immediately after completing the swing phase for the paretic leg 104 (or the prosthetic leg 320). The user device 148 or the control computing device 144 may compare the second maximum elevation to the maximum elevation for the toe region and determine that the second maximum elevation for the toe region of the paretic leg is greater than the maximum elevation for the toe region of the paretic leg 104 (or the prosthetic leg 320).

The user device 148 or the control computing device 144 may modify at least one of the electrical stimuli or the motorized assistance provided to the paretic leg 104 (or the prosthetic leg 320) during the next swing phase for the paretic leg (or the prosthetic leg 320) based on the second maximum elevation being greater than the maximum elevation in order to attempt to correct the error. For example, the user device 148 or the control computing device 144 may determine an amount of adjustment and which portions of the motorized assistance and/or electrical stimuli to adjust based on the second maximum elevation being greater than the maximum elevation and/or the amount that the second maximum elevation is greater than the maximum elevation. For example, the user device 148 or the control computing device 144 may send a signal to one or more of the motors 128, 152, or 328, 352, electrodes 130A-B, 132, 204a-n, and/or to the pulse generator 202 to indicate one or more adjusted settings or outputs for the motorized assistance and/or the electrical stimuli in response to the second maximum elevation for the toe region of the paretic leg 104 (or the prosthetic leg 320) being greater than the maximum elevation for the toe region.

Returning to the error determination, for example, determining the error with at least a portion of the trajectory of the swing phase of the gait motion of the paretic leg (or the prosthetic leg 320) may comprise the user device 148 or the control computing device 144 determining an orientation (e.g., an angle of orientation) of a thigh portion 108 of the paretic leg 104 (or the thigh section 322 of the prosthetic leg 320) at a time of the swing phase for the paretic leg 104 (or the prosthetic leg 320). For example, the orientation of the thigh portion 108 of the paretic leg 104 (or the thigh section 322 of the prosthetic leg 320) may be determined based on the additional sensor data. For example, the angle of orientation of the thigh portion 108 (or the thigh section 322) may comprise an angle of orientation of a longitudinal axis α of the thigh portion 108 (or the thigh section 322). The user device 148 or the control computing device 144 may determine the orientation of the thigh portion 108 (or the thigh section 322) is incorrect at the time of the swing phase of the paretic leg 104 (or the prosthetic leg 320). For example, the user device 148 or the control computing device 144 may compare the orientation of the thigh portion 108 (or the thigh section 322) to the expected orientation (e.g., expected angle of orientation) of the thigh portion 108 (or the thigh section 322) during the swing phase at the particular time during the swing phase. The user device 148 or control computing device 144 may determine the orientation of the thigh portion 108 (or the thigh section 322) during the time of the swing phase is incorrect based on orientation for the thigh portion 108 (or the thigh section 322) being different than the expected orientation for the thigh portion 108 (or the thigh section 322) and/or the difference of the orientation and expected orientation being outside (e.g., not satisfying) an orientation threshold for the thigh portion 108 (or the thigh section 322) during the swing phase.

The user device 148 or the control computing device 144 may modify at least one of the electrical stimuli or the motorized assistance provided to the paretic leg 104 (or the prosthetic leg 320) during the next swing phase for the paretic leg 104 (or the prosthetic leg 320) based on the orientation of the thigh portion 108 (or the thigh section 322) being incorrect at the time of the swing phase for the paretic leg 104 (or the prosthetic leg 320). For example, the user device 148 or the control computing device 144 may determine an amount of adjustment and which portions of the motorized assistance and/or electrical stimuli to adjust based on the orientation of the thigh portion 108 (or the thigh section 322) being different than the expected orientation and/or the amount of difference between the orientation of the thigh portion 108 (or the thigh section 322) and the expected orientation for the thigh portion 108 (or the thigh section 322). For example, the user device 148 or the control computing device 144 may send a signal to one or more of the motors 128, 152, or 328, 352, electrodes 130A-B, 132, 204a-n, and/or to the pulse generator 202 to indicate one or more adjusted settings or outputs for the motorized assistance and/or the electrical stimuli for the next swing phase for the paretic leg 104 (or the prosthetic leg 320) in response to the orientation of the thigh portion 108 (or the thigh section 322) being incorrect at the time of the swing phase of the paretic leg 104 (or the prosthetic leg 320).

Returning to the error determination, for example, determining the error with at least a portion of the trajectory of the swing phase of the gait motion of the paretic leg 104 (or the prosthetic leg 320) may comprise the user device 148 or the control computing device 144 determining a time of an initiation of a knee extension of the paretic leg 104 (or the prosthetic leg 320) during the swing phase. For example, the time of initiation of the knee extension of the paretic leg 104 (or the prosthetic leg 320) may be determined based on the additional sensor data. The user device 148 or the control computing device 144 may determine the time of initiation of the knee extension for the paretic leg 104 (or the prosthetic leg 320) during the swing phase is either earlier than a target time or later than the target time. For example, the user device 148 or the control computing device 144 may compare the time of initiation of the knee extension for the paretic leg 104 (or the prosthetic leg 320) to the target time for the initiation of the knee extension during the swing phase. Based on the comparison, the user device 148 or control computing device 144 may determine the time of initiation of the knee extension is earlier or later than the target time for initiation of the knee extension during the swing phase for the paretic leg 104 (or the prosthetic leg 320).

The user device 148 or the control computing device 144 may modify at least one of the electrical stimuli or the motorized assistance provided to the paretic leg 104 (or the prosthetic leg 320) during the next swing phase for the paretic leg 104 (or the prosthetic leg 320) based on the time of initiation of the knee extension during the swing phase being earlier or later than the target time for initiation of the knee extension for the paretic leg 104 (or the prosthetic leg 320). For example, the user device 148 or the control computing device 144 may determine an amount of adjustment and which portions of the motorized assistance and/or electrical stimuli to adjust based on whether the time of initiation of the knee extension is earlier or later than the target time and/or based on the amount of time that the time of initiation of the knee extension is earlier or later. For example, the user device 148 or the control computing device 144 may send a signal to one or more of the motors 128, 152, or 328, 352 electrodes 130A-B, 132, 204a-n, and/or to the pulse generator 202 to indicate one or more adjusted settings or outputs for the motorized assistance and/or the electrical stimuli for the next swing phase for the paretic leg 104 (or the prosthetic leg 320) in response to the time of the initiation of the knee extension being earlier or later than the target time of initiation of the knee extension for the paretic leg 104 (or the prosthetic leg 320).

Returning to the error determination, for example, determining the error with at least a portion of the trajectory of the swing phase of the gait motion of the paretic leg 104 (or the prosthetic leg 320) may comprise the user device 148 or the control computing device 144 determining a position of the pelvic portion 107 of the paretic leg 104 (or hip section 350 of the prosthetic leg 320) at a first time during the swing phase. For example, the position of the pelvic portion 107 of the paretic leg 104 (or hip section 350 of the prosthetic leg 320) at the first time may be determined based on the additional sensor data. In certain examples, the position of the pelvic portion 107 (or hip section 350) at the first time may be inferred from the position data for one or more of the thigh portion 108 (or the thigh section 322) and the shank portion 110 (or the shank section 324). The user device 148 or the control computing device 144 may determine the position for the pelvic portion 107 for the paretic leg 104 (or hip section 350 of the prosthetic leg 320) at the first time during the swing phase is incorrect. For example, the user device 148 or the control computing device 144 may compare the position of the pelvic portion 107 for the paretic leg 104 (or hip section 350 of the prosthetic leg 320) at the first time to the expected position of the pelvic portion 107 (or hip section 350) at the first time during the swing phase. Based on the comparison, the user device 148 or control computing device 144 may determine the position of the pelvic portion 107 (or hip section 350) at the first time during the swing phase is incorrect based on position of the pelvic portion 107 (or hip section 350) during the first time being different than the expected position for the pelvic portion 107 (or hip section 350) at the first time and/or the difference for the position of the pelvic portion 107 (or hip section 350) and expected position for the pelvic portion 107 (or hip section 350) being outside a position threshold for the pelvic portion 107 (or hip section 350) during the swing phase.

The user device 148 or the control computing device 144 may modify at least one of the electrical stimuli or the motorized assistance provided to the paretic leg 104 (or the prosthetic leg 320) during the next swing phase for the paretic leg 104 (or the remaining portion of the pelvic area of the amputated leg) based on the position of the pelvic portion of the paretic leg 104 (or the remaining portion of the pelvic area of the amputated leg) being incorrect at the first time of the swing phase. For example, the user device 148 or the control computing device 144 may determine an amount of adjustment and which portions of the motorized assistance and/or electrical stimuli to adjust based on the position of the pelvic portion 107 of the paretic leg 104 (or the remaining portion of the pelvic area of the amputated leg) being incorrect at the first time of the swing phase and/or based on the how much out of position the pelvic portion 107 (or hip section 350) is. For example, the user device 148 or the control computing device 144 may send a signal to one or more of the motors 128, 152, or 328, 352, electrodes 130A-B, 132, 204a-n, and/or to the pulse generator 202 to indicate one or more adjusted settings or outputs for the motorized assistance and/or the electrical stimuli for the next swing phase for the paretic leg 104 (or the prosthetic leg 320) in response to the position for the pelvic portion 107 of the paretic leg 104 (or the remaining portion of the pelvic area of the amputated leg) being incorrect at the first time of the swing phase.

Modifying at least one of the electrical stimuli or the motorized assistance to the paretic leg 104 (or the prosthetic leg 320) may comprise at least one of modifying a time to supply the electrical stimuli to the paretic leg 104 (or the remaining portion of the thigh of the amputated leg) during the next swing phase, modifying a level of electrical stimuli supplied to the paretic leg 104 (or the remaining portion of the thigh of the amputated leg) during the next swing phase, modifying a length of time the electrical stimuli is supplied to the paretic leg 104 (or the remaining portion of the thigh of the amputated leg) during the next swing phase, modifying a second time to supply the motorized assistance to the paretic leg 104 (or the prosthetic leg 320) during the next swing phase, modifying a level of motorized assistance to the paretic leg 104 (or the prosthetic leg 320) during the next swing phase, or modifying a second length of time the motorized assistance is supplied to the paretic leg 104 (or the prosthetic leg 320) during the next swing phase.

For example, based on the sensor data for the paretic leg 104 (or the prosthetic leg 320), the second sensor data for the non-paretic leg 106, and/or the calculated estimate of center of mass for the body of the user 102, the user device 148 or the control computing device 144 may determine that the paretic leg is in a stance phase. For example, the stance phase may be one of heel-strike, foot flat, midstance, heel off, or toe off. For example, the user device 144 or the control computing device 148, based on determining the paretic leg 104 (or the prosthetic leg 320) is in a stance phase, may send a signal to provide at least one of electrical stimuli or motorized assistance (e.g., via the brace 120 (or the prosthetic leg 320)) to all or at least a portion of the paretic leg 104 (or the prosthetic leg 320).

Based on the determination that the paretic leg 104 (or the prosthetic leg 320) is in the stance phase, the user device 148 or the control computing device 144 may receive third sensor data. It should be understood that reference to “third” sensor data in the specification is only to separate it from the sensor data, the second sensor data, and the additional sensor data. Nothing with regard to timing or preference is intended by the use of the phrase “third sensor data.” The third sensor data may be associated with the paretic leg 104 (or the prosthetic leg 320) and/or the calculated estimate of center of mass for the body of the user 102. For example, the third sensor data may be received at a third time that is subsequent to the first time that the sensor data was received. For example, the third sensor data may comprise all or any portion of the forms of sensor data received at the first time. For example, the third sensor data may comprise data associated with the paretic leg 104 (or the prosthetic leg 320) that was not included in the sensor data received at the first time. The third sensor data may be received from any one or more of the sensors 129, 134-142, 154, 156 or 329, 334-338, 354, 356.

The user device 148 or the control computing device 144 may determine an error with at least a portion of a trajectory of the stance phase of the gait motion of the paretic leg 104 (or the prosthetic leg 320). For example, the trajectory may be determined based on one or more of all or a portion of the sensor data or all or a portion of the third sensor data. For example, the error may be determined based on one or more of the trajectory of the stance phase for the paretic leg 104 (or the prosthetic leg 320) or all or a portion of the sensor data and/or the third sensor data. For example, the user device 148 or the control computing device 144 may compare the trajectory (e.g., position, angular velocity, acceleration, rotational relation, muscle activity, and/or angle of orientation of the thigh 108, shank 110, and/or foot 112 portions) of the stance phase of the paretic leg 104 (or the thigh 322, shank 324, and/or foot 326 sections of the prosthetic leg 320) to an optimal trajectory of the stance phase (e.g., optimal angular velocity, optimal position, optimal acceleration, optimal rotational relation, and/or optimal angle of orientation). Based on a determination that the trajectory of the stance phase of the paretic leg 104 (or the prosthetic leg 320) does not match or is not within one or more predetermined trajectory or position thresholds for the stance phase, the user device 148 or control computing device 144 may determine that the paretic leg 104 (or the prosthetic leg 320) is not moving properly or efficiently through the stance phase.

For example, the angular velocity of the thigh portion 108 (or the thigh section 322) may be compared to the optimal angular velocity for the thigh portion 108 (or the thigh section 322), the position of the thigh portion 108 (or the thigh section 322) may be compared to the optimal position for the thigh portion 108 (or the thigh section 322), the acceleration of the thigh portion 108 (or the thigh section 322) may be compared to the optimal acceleration for the thigh portion 108 (or the thigh section 322), the angle of orientation for the thigh portion 108 (or the thigh section 322) may be compared to the optimal angle of orientation for the thigh portion (or the thigh section 322). Similar analysis may be completed for the shank portion 110 (or the shank section 324) and/or the foot 112 (or the foot section 326).

For example, the trajectory of the stance phase may be divided into a plurality of portions of the trajectory and the target trajectory may be similarly divided into a plurality of portions of a target trajectory. This allows for the determination of error along discreet portions of the trajectory of the stance phase. The plurality of portions of the trajectory may be determined based on one or more of all or a portion of the sensor data or all or a portion of the additional sensor data. For example, the error may be determined based on one or more of the trajectory (or plurality of portions thereof) of the stance phase for the paretic leg 104 (or the prosthetic leg 320) and/or all or a portion of the sensor data and/or the additional sensor data. For example, the user device 148 or the control computing device 144 may compare the trajectory (e.g., position, angular velocity, acceleration, rotational relation, muscle activity, and/or angle of orientation of the thigh 108, shank 110, and/or foot 112 portions) of each of a plurality of portions of the stance phase of the paretic leg 104 (or the thigh 322, shank 324 and/or foot 326 sections of the prosthetic leg 320) to an optimal or target trajectory of the corresponding plurality of portions of the stance phase (e.g., optimal angular velocity, optimal position, optimal acceleration, optimal rotational relation, and/or optimal angle of orientation). Based on a determination that the trajectory of the stance phase or one or more of the plurality of portions of the stance phase of the paretic leg 104 (or the prosthetic leg 320) does not match or is not within one or more predetermined trajectory or position thresholds for the stance phase (or that respective portion of the plurality of portions of the stance phase), the user device 148 or control computing device 144 may determine that the paretic leg 104 (or the prosthetic leg 320) is not moving properly or efficiently through all or particular portions of the plurality of portions of the stance phase. For example, the angular velocity of the thigh portion 108 (or the thigh section 322) may be compared to the optimal angular velocity for the thigh portion 108 (or the thigh section 322), the position of the thigh portion 108 (or the thigh section 322) may be compared to the optimal position for the thigh portion 108 (or the thigh section 322), the acceleration of the thigh portion 108 (or the thigh section 322) may be compared to the optimal acceleration for the thigh portion 108 (or the thigh section 322), the angle of orientation for the thigh portion 108 (or the thigh section 322) may be compared to the optimal angle of orientation for the thigh portion (or the thigh section 322) for the entire trajectory and/or for each of the plurality of portions of the trajectory for the stance phase. Similar analysis may be completed for the pelvic portion 107 (or hip section 350), the knee portion 109 (or the knee section 309), the shank portion 110 (or the shank section 324) and/or the foot 112 (or the foot section 326) for the entire trajectory and/or for each of the plurality of portions of the trajectory for the stance phase. In certain examples, the position, velocity, acceleration, and/or angular orientation of the pelvic portion 107 (or hip section 350) may be inferred from the data for the thigh portion 108 (or the thigh section 322) and the shank portion 110 (or the shank section 324).

In another example, trajectory may be determined as function of the kinematics of one portion of the paretic leg 104 (or the prosthetic leg 320) with respect to one or more other portions of the paretic leg 104 (or the prosthetic leg 320) for the plurality of portions of the stance phase. For example, maintaining adequate knee 109 (or the knee section 309) extension and a pelvic 107 (or hip section 350) progression (e.g., smoothness of movement and velocity) may be inferred from the joint angles of the paretic leg 104 (or the prosthetic leg 320) during a plurality of portions of the stance phase and may be evaluated to determine the trajectory and error in trajectory for the paretic leg 104 (or the prosthetic leg 320).

Based on the determination that there is an error and based on the amount of error or offset for the paretic leg 104 (or the prosthetic leg 320) or a portion thereof, the user device 148 or the control computing device 144 may determine which of the motorized assistance and/or the electrical stimuli to adjust and how much one or both should be adjusted. For example, the user device 148 or the control computing device 144 can compare the amount of error and the location and/or phase of the gait motion where the error was detected to a database of gait adjustment parameters in or accessible to the user device 148 and/or the control computing device 144 to determine whether to adjust one or both of the motorized assistance or the electrical stimuli and the amount and location (e.g. for electrical stimuli) for providing the adjustment.

The user device 148 or the control computing device 144 may modify at least one of the electrical stimuli or the motorized assistance provided to the paretic leg 104 (or the prosthetic leg 320) during the next stance phase for the paretic leg in order to attempt to correct the error. For example, the user device 148 or the control computing device 144 may send a signal to one or more of the motors 128, 152, or 328, 352, electrodes 130A-B, 132, 204a-n, and/or to the pulse generator 202 to indicate one or more adjusted settings or outputs for the motorized assistance and/or the electrical stimuli. The modification of at least one of the electrical stimuli or the motorized assistance may be based on the determined error. For example, the modification may be based on the analysis of the database of gait adjustment parameters and the amount of error detected.

Returning to the error determination, for example, determining the error with at least a portion of the trajectory of the stance phase of the gait motion may comprise the user device 148 or the control computing device 144 determining an amount of knee (or the knee section 309) extension of the paretic leg 104 (or the prosthetic leg 320) during the stance phase of the paretic leg 104 (or the prosthetic leg 320). For example, the amount of the knee extension may be determined based on the third sensor data. The user device 148 or the control computing device 144 may determine the amount of knee extension for the paretic leg 104 (or the prosthetic leg 320) during the stance phase does not satisfy a knee extension threshold. For example, the amount of knee extension may not satisfy the knee extension threshold if the amount of knee extension is less than or less than or equal to the knee extension threshold. For example, the user device 148 or the control computing device 144 may compare the amount of knee extension for the paretic leg 104 (or the prosthetic leg 320) during the stance phase to the knee extension threshold. Based on the comparison, the user device 148 or control computing device 144 may determine that the amount of knee extension for the paretic leg 104 (or the prosthetic leg 320) during the stance phase does not satisfy the knee extension threshold.

The user device 148 or the control computing device 144 may modify at least one of the electrical stimuli or the motorized assistance provided to the paretic leg 104 (or the prosthetic leg 320) during the next stance phase for the paretic leg 104 (or the prosthetic leg 320) based on the amount of knee extension during the stance phase for the paretic leg 104 (or the prosthetic leg 320) not satisfying the knee extension threshold, in order to attempt to correct the error. For example, the user device 148 or the control computing device 144 may determine an amount of adjustment and which portions of the motorized assistance and/or electrical stimuli to adjust based on the amount of knee extension not satisfying the knee extension threshold and/or the difference between the amount of knee extension for the paretic leg 104 (or the prosthetic leg 320) during the stance phase and the knee extension threshold. For example, the user device 148 or the control computing device 144 may send a signal to one or more of the motors 128, 152, or 328, 352, electrodes 130A-B, 132, 204a-n, and/or to the pulse generator 202 to indicate one or more adjusted settings or outputs for the motorized assistance and/or the electrical stimuli in response to the amount of knee extension for the paretic leg during the stance phase not satisfying the knee extension threshold.

Modifying at least one of the electrical stimuli or the motorized assistance to the paretic leg 104 (or the prosthetic leg 320) may comprise at least one of modifying a time to supply the electrical stimuli to the paretic leg 104 (or the remaining portion of the thigh of the amputated leg) during the next stance phase, modifying a level of electrical stimuli supplied to the paretic leg 104 (or the remaining portion of the thigh of the amputated leg) during the next stance phase, modifying a length of time the electrical stimuli is supplied to the paretic leg 104 (or the remaining portion of the thigh of the amputated leg) during the next stance phase, modifying a second time to supply the motorized assistance to the paretic leg 104 (or the prosthetic leg 320) during the next stance phase, modifying a level of motorized assistance to the paretic leg 104 (or the prosthetic leg 320) during the next stance phase, or modifying a second length of time the motorized assistance is supplied to the paretic leg 104 (or the prosthetic leg 320) during the next stance phase.

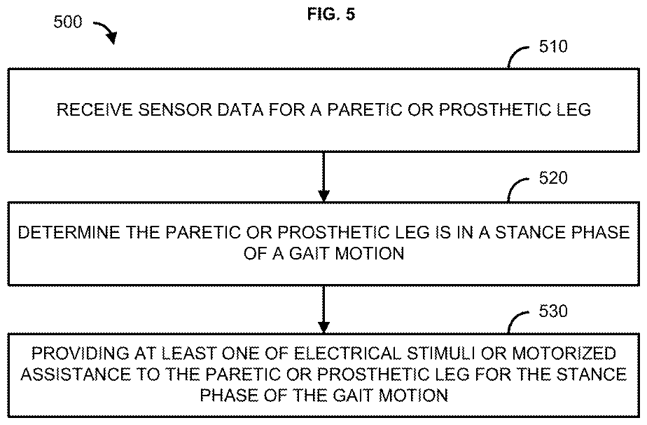

FIG. 5 shows an example method 500 for providing motorized assistance and/or electrical stimuli for leg movement. Referring to FIGS. 1-3 and 5, the method 500 may be completed by one or more of the control computing device 144, the user device 148, the brace 120 (or the prosthetic leg 320), and/or the pulse generator 202. The method 500 may use sensor data to evaluate the current activity of the user 102 (e.g., such as a phase of a gait motion, walking, standing, transitioning between walking and standing, etc.) and determine what, if any, motorized assistance and/or electrical stimuli to provide to the paretic leg 104 (or the prosthetic leg 320) of the user 102. For example, the method 500 may determine which phase of a gait cycle the paretic leg 104 (or the prosthetic leg 320) is currently in and determine, based on that phase, what and how much motorized assistance and/or electrical stimuli to provide to the paretic leg 104 (or the prosthetic leg 320).

At 510, sensor data may be received. For example, the sensor data may be associated with the paretic leg 104 (or the prosthetic leg 320). For example, the sensor data may be received from one or more sensors (e.g., the sensors 129, 134-138, 154, 156 or 329, 334-338, 354, 356) located on and/or receiving data about the paretic leg 104 (or the prosthetic leg 320). For example, the sensor data may comprise a calculated estimate of a center of mass of the body of the user 102. For example, the sensor data may be received by a computing device, such as the control computing device 144 and/or the user device 148, from one or more of the sensors 129, 134-138, 154, 156 or 329, 334-338, 354, 356. The sensor data may be received at a first time. For example, the sensor data may comprise one or more of velocity data (e.g., angular velocity data) for of all or a portion of the paretic leg 104 (or the prosthetic leg 320), acceleration data of all or a portion of the paretic leg 104, orientation data of all or a portion of the paretic leg 104 (or the prosthetic leg 320), position data for all or a portion of the paretic leg 104 (or the prosthetic leg 320), muscle activity data for all or a portion of the paretic leg 104 (or the remaining portion of the thigh of the amputated leg), or rotational relation data for one portion with respect to another portion of the paretic leg 104 (or the prosthetic leg 320). For example, the portion of the paretic leg 104 (or the prosthetic leg 320) may comprise one of the thigh portion 108 (or the thigh section 322) of the paretic leg 104 (or the thigh section 322 of the prosthetic leg 320), the shank portion 110 of the paretic leg 104 (or the shank section 324 of the prosthetic leg 320), or the foot 112 of the paretic leg 104 (or the foot section 326 of the prosthetic leg 320).

For example, the sensor data may comprise one or more of an orientation (e.g., an angle of orientation) for the thigh portion 108 of the paretic leg 104 (or the thigh section 322 of the prosthetic leg 320), an acceleration of the thigh portion 108, an angular velocity of the thigh portion 108 (or the thigh section 322), a position of the thigh portion 108 (or the thigh section 322), muscle activity data for a thigh portion 108 (or the remaining portion of the thigh of the amputated leg), or rotational relation data of the thigh portion 108 (or the thigh section 322) with respect to the shank portion 110 (or the shank section 324). For example, the angle of orientation for the thigh portion 108 (or the thigh section 322) may be determined based on the angle between the longitudinal axis α of the thigh portion 108 (or the thigh section 322) and one of a vertical axis and a horizontal axis. For example, the sensor data may comprise one or more of an orientation (e.g., an angle of orientation) for the shank portion 110 of the paretic leg 104 (or the shank section 324 of the prosthetic leg 320), an acceleration of the shank portion 110 (or the shank section 324), an angular velocity of the shank portion 110 (or the shank section 324), a position of the shank portion 110 (or the shank section 324), muscle activity data for a shank portion 110, or rotational relation data of the shank portion 110 (or the shank section 324) with respect to the foot 112 (or the foot section 326). For example, the angle of orientation for the shank portion 110 (or the shank section 324) may be determined based on the angle between the longitudinal axis β of the shank portion 110 (or the shank section 324) and one of a vertical axis and a horizontal axis. For example, the sensor data may comprise heel-strike or foot-floor contact data for the paretic leg 104 (or the prosthetic leg 320). For example, the sensor data may comprise a calculated estimate of a center of mass of the body of the user 102.

For example, the computing device, such as the control computing device 144 or the user device 148, may receive second sensor data. For example, the second sensor data may be received from one or more of the sensors 140, 142, 206 or any other sensors or encoders coupled to or associated with the non-paretic leg 106 of the user 102. For example, the second sensor data may comprise orientation data, acceleration data, velocity data (e.g., angular velocity data), position data, heel strike data, encoder data, muscle activity data, and/or foot-floor contact data for all or similar portions of the non-paretic leg 106.

At 520, the paretic leg 104 (or the prosthetic leg 320) may be determined to be in the stance phase (e.g., heel-strike, foot flat, midstance, heel off, toe off) of a gait motion of the user 102. The paretic leg 104 (or the prosthetic leg 320) being in the stance phase may be determined by the user device 148, the control computing device 144 or any other computing device. For example, the paretic leg 104 (or the prosthetic leg 320) being in the stance phase may be determined based on the received sensor data for the paretic leg 104 (or the prosthetic leg 320). For example, determining the paretic leg 104 (or the prosthetic leg 320) is in the stance phase may be determined based on an orientation of the thigh portion 108 of the paretic leg 104 (or the thigh section 322 of the prosthetic leg 320) and an angular velocity of the thigh portion 108 (or the thigh section 322). For example, determining the paretic leg 104 (or the prosthetic leg 320) is in the stance phase may be determined based on the orientation of the thigh portion 108 (or the thigh section 322) and the orientation of the shank portion 110 of the paretic leg 104 (or the shank section 324 of the prosthetic leg 320). For example, determining the paretic leg 104 (or the prosthetic leg 320) is in the stance phase may be determined based on the heel-strike or pressure data from the sensor that detects heel-strike 138, 338. For example, determining the paretic leg 104 (or the prosthetic leg 320) is in the stance phase may be determined based on the heel-strike or pressure data from the sensor that detects heel-strike 138, 338, the orientation, angular velocity, muscle activity, and/or position data for the thigh portion 108 (or the thigh section 322) from the thigh sensor 134, 334, and/or the orientation, angular velocity, muscle activity, and/or position data for the shank portion 110 (or the shank section 324) from the shank sensor 136, 336. For example, determining the paretic leg 104 (or the prosthetic leg 320) is in the stance phase may further be determined based on the velocity data (e.g., angular velocity data) for the shank portion 110 of the paretic leg 104 (or the shank section 324 of the prosthetic leg 320). For example, determining the paretic leg 104 (or the prosthetic leg 320) is in the stance phase may further be determined based on all or any portion of the second sensor data associated with the non-paretic leg 106 of the user 102. For example, determining the paretic leg 104 (or the prosthetic leg 320) is in the stance phase may further be determined based on the calculated estimate of the center of mass of the body of the user 102. For example, determining the paretic leg 104 (or the prosthetic leg 320) is in the early portion (e.g., heel-strike portion) of the stance phase may be based on heel-strike data for the paretic leg 104 (or the prosthetic leg 320). For example, determining the paretic leg 104 (or the prosthetic leg 320) is in the early portion of the stance phase may further be determined based on the calculated estimate of the center of mass of the body of the user 102. For example, determining the paretic leg 104 (or the prosthetic leg 320) is in the midstance to toe-off portions of the stance phase may be based on an angle of orientation of the shank portion 110 (or the shank section 324) and/or thigh portion 108 (or the thigh section 322). For example, determining the paretic leg 104 (or the prosthetic leg 320) is in the midstance to toe-off portions of the stance phase may be further based on the angular velocity for one or more of the shank portion 110 (or the shank section 324) or thigh portion 108 (or the thigh section 322). For example, determining the paretic leg 104 (or the prosthetic leg 320) is in the midstance to toe-off portions of the stance phase may further be determined based on the calculated estimate of the center of mass of the body of the user 102.

At 530, at least one of electrical stimuli or motorized assistance may be provided to the paretic leg 104 (or the prosthetic leg 320). For example, the user device 148, the control computing device 144, or another computing device may cause the electrical stimuli and/or the motorized assistance to be provided to the paretic leg 104 (or the prosthetic leg 320). For example, the user device 148 or the control computing device 144 may send a signal to one or more of the motors 128, 152 or 328, 352 (e.g., via the network device 146) to provide motorized assistance and/or to one or more of the electrodes 130A-B, 132, 204a-n and/or the pulse generator 202 to provide electrical stimuli to the paretic leg 104 (or the prosthetic leg 320). The electrical stimuli and/or motorized assistance may be provided based on the determination that the paretic leg 104 (or the prosthetic leg 320) is in the stance phase of the gait motion for the user 102.

For example, the motorized assistance may be provided by providing the motorized assistance via the neuroprosthesis, exoskeleton, or brace 120 coupled to the paretic leg 104, or the prosthetic leg 320. For example, the motor 128, 328 of the brace 120 (or the prosthetic leg 320) may provide motorized assistance by causing the shank section 124 of the brace 120 (or the shank section 324 of the prosthetic leg 320) to rotate with respect to the thigh section 122 of the brace 120 (or the thigh section 322 of the prosthetic leg 320). For example, the motor 152, 352 of the brace 120 (or the prosthetic leg 320) may provide motorized assistance by causing the thigh section 122 of the brace 120 (or the thigh section 322 of the prosthetic leg 320) to rotate with respect to the hip section 150 of the brace 120 (or hip section 350 of the prosthetic leg 320). For example, the electrodes 130A-B, 132, 204a-n and/or the pulse generator 202 may provide electrical stimuli to portions of the paretic leg 104 (or the remaining portion of the thigh of the amputated leg) by sending electrical pulses into the muscles of the paretic leg 104 (or the remaining portion of the thigh of the amputated leg). Accordingly, electrical stimuli may be provided to all or one or more portions of the paretic leg 104 (or the remaining portion of the thigh of the amputated leg) by one or more of embedded electrodes 204a-n providing internal electrical stimuli or surface electrodes 130A-B, 132 providing external electrical stimulus. For example, the amount, location, and type of motorized assistance or electrical stimuli provided may vary based on the current part (e.g., heel-strike, foot flat, midstance, heel off, toe off) of the stance phase of the gait motion and the position of the paretic leg 104 (or the prosthetic leg 320) within that current part of the stance phase of the gait motion.

The user device 148 or the control computing device 144 may receive third sensor data. It should be understood that reference to “third” sensor data in the specification is only to separate it from the sensor data and the second sensor data. Nothing with regard to timing or preference is intended by the use of the phrase “third sensor data.” The third sensor data may be associated with the paretic leg 104 (or the prosthetic leg 320) and/or the calculated estimate of the center of mass of the body of the user 102. For example, the third sensor data may be received at a third time that is subsequent to the first time that the sensor data was received. For example, the third sensor data may comprise all or any portion of the forms of sensor data received at the first time. For example, the third sensor data may comprise data associated with the paretic leg 104 (or the prosthetic leg 320) that was not included in the sensor data received at the first time. The third sensor data may be received from any one or more of the sensors 129, 134-142, 154, 156 or 329, 334-338, 354, 356.

The user device 148 or the control computing device 144 may determine an error with at least a portion of a trajectory of the stance phase of the gait motion of the paretic leg 104 (or the prosthetic leg 320). For example, the trajectory may be determined based on one or more of all or a portion of the sensor data or all or a portion of the third sensor data. For example, the error may be determined based on one or more of the trajectory of the stance phase for the paretic leg 104 (or the prosthetic leg 320) or all or a portion of the sensor data and/or the third sensor data. For example, the user device 148 or the control computing device 144 may compare the trajectory (e.g., position, angular velocity, acceleration, rotational relation, muscle activity, and/or angle of orientation of the thigh 108, shank 110, and/or foot 112 portions) of the stance phase of the paretic leg 104 (or the thigh 322, shank 324, and/or foot 326 sections of the prosthetic leg 320) to an optimal trajectory of the stance phase (e.g., optimal angular velocity, optimal position, optimal acceleration, optimal rotational relation, and/or optimal angle of orientation). Based on a determination that the trajectory of the stance phase of the paretic leg 104 (or the prosthetic leg 320) does not match or is not within one or more predetermined trajectory or position thresholds for the stance phase, the user device 148 or control computing device 144 may determine that the paretic leg 104 (or the prosthetic leg 320) is not moving properly or efficiently through the stance phase. For example, the angular velocity of the thigh portion 108 (or the thigh section 322) may be compared to the optimal angular velocity for the thigh portion 108 (or the thigh section 322), the position of the thigh portion 108 (or the thigh section 322) may be compared to the optimal position for the thigh portion 108 (or the thigh section 322), the acceleration of the thigh portion 108 (or the thigh section 322) may be compared to the optimal acceleration for the thigh portion 108 (or the thigh section 322), the angle of orientation for the thigh portion 108 (or the thigh section 322) may be compared to the optimal angle of orientation for the thigh portion (or the thigh section 322). Similar analysis may be completed for the shank portion 110 (or the shank section 324) and/or the foot 112 (or the foot section 326).

For example, the trajectory of the stance phase may be divided into a plurality of portions of the trajectory and the target trajectory may be similarly divided into a plurality of portions of a target trajectory. This allows for the determination of error along discreet portions of the trajectory of the stance phase. The plurality of portions of the trajectory may be determined based on one or more of all or a portion of the sensor data or all or a portion of the additional sensor data. For example, the error may be determined based on one or more of the trajectory (or plurality of portions thereof) of the stance phase for the paretic leg 104 (or the prosthetic leg 320) and/or all or a portion of the sensor data and/or the additional sensor data. For example, the user device 148 or the control computing device 144 may compare the trajectory (e.g., position, angular velocity, acceleration, rotational relation, muscle activity, and/or angle of orientation of the thigh 108, shank 110, and/or foot 112 portions) of each of a plurality of portions of the stance phase of the paretic leg 104 (or the thigh 322, shank 324, and/or foot 326 sections of the prosthetic leg 320) to an optimal or target trajectory of the corresponding plurality of portions of the stance phase (e.g., optimal angular velocity, optimal position, optimal acceleration, optimal rotational relation, and/or optimal angle of orientation). Based on a determination that the trajectory of the stance phase or one or more of the plurality of portions of the stance phase of the paretic leg 104 (or the prosthetic leg 320) does not match or is not within one or more predetermined trajectory or position thresholds for the stance phase (or that respective portion of the plurality of portions of the stance phase), the user device 148 or control computing device 144 may determine that the paretic leg 104 (or the prosthetic leg 320) is not moving properly or efficiently through all or particular portions of the plurality of portions of the stance phase. For example, the angular velocity of the thigh portion 108 (or the thigh section 322) may be compared to the optimal angular velocity for the thigh portion 108 (or the thigh section 322), the position of the thigh portion 108 (or the thigh section 322) may be compared to the optimal position for the thigh portion 108 (or the thigh section 322), the acceleration of the thigh portion 108 (or the thigh section 322) may be compared to the optimal acceleration for the thigh portion 108 (or the thigh section 322), the angle of orientation for the thigh portion 108 (or the thigh section 322) may be compared to the optimal angle of orientation for the thigh portion (or the thigh section 322) for the entire trajectory and/or for each of the plurality of portions of the trajectory for the stance phase. Similar analysis may be completed for the pelvic portion 107 (or hip section 350), the knee portion 109 (or the knee section 309), the shank portion 110 (or the shank section 324) and/or the foot 112 (or the foot section 326) for the entire trajectory and/or for each of the plurality of portions of the trajectory for the stance phase. In certain examples, the position, velocity, acceleration, and/or angular orientation of the pelvic portion 107 (or hip section 350) may be inferred from the data for the thigh portion 108 (or the thigh section 322) and the shank portion 110 (or the shank section 324).

In another example, trajectory may be determined as function of the kinematics of one portion of the paretic leg 104 (or the prosthetic leg 320) with respect to one or more other portions of the paretic leg 104 (or the prosthetic leg 320) for the plurality of portions of the stance phase. For example, maintaining adequate knee 109 (or the knee section 309) extension and a pelvic 107 (or hip section 350) progression (e.g., smoothness of movement and velocity) may be inferred from the joint angles of the paretic leg 104 (or the prosthetic leg 320) during a plurality of portions of the stance phase and may be evaluated to determine the trajectory and error in trajectory for the paretic leg 104 (or the prosthetic leg 320).

Based on the determination that there is an error and/or based on the amount of error or offset for the paretic leg 104 (or the prosthetic leg 320) or a portion thereof, the user device 148 or the control computing device 144 may determine which of the motorized assistance and/or the electrical stimuli to adjust and how much one or both should be adjusted. For example, the user device 148 or the control computing device 144 may compare the amount of error and the location and/or phase of the gait motion where the error was detected to a database of gait adjustment parameters in or accessible to the user device 148 and/or the control computing device 144 to determine whether to adjust one or both of the motorized assistance or the electrical stimuli and the amount and location (e.g. for electrical stimuli) for providing the adjustment.

The user device 148 or the control computing device 144 may modify at least one of the electrical stimuli or the motorized assistance provided to the paretic leg 104 (or the prosthetic leg 320) during the next stance phase for the paretic leg in order to attempt to correct the error. For example, the user device 148 or the control computing device 144 may send a signal to one or more of the motors 128, 152 or 328, 352, electrodes 130A-B, 132, 204a-n, and/or to the pulse generator 202 to indicate one or more adjusted settings or outputs for the motorized assistance and/or the electrical stimuli. The modification of at least one of the electrical stimuli or the motorized assistance may be based on the determined error. For example, the modification may be based on the analysis of the database of gait adjustment parameters and the amount of error detected.

Returning to the error determination, for example, determining the error with at least a portion of the trajectory of the stance phase of the gait motion may comprise the user device 148 or the control computing device 144 determining an amount of knee extension of the paretic leg 104 (or the prosthetic leg 320) during the stance phase of the paretic leg 104 (or the prosthetic leg 320). For example, the amount of the knee extension may be determined based on the third sensor data. The user device 148 or the control computing device 144 may determine the amount of knee extension for the paretic leg 104 (or the prosthetic leg 320) during the stance phase does not satisfy a knee extension threshold. For example, the amount of knee extension may not satisfy the knee extension threshold if the amount of knee extension is less than or less than or equal to the knee extension threshold. For example, the user device 148 or the control computing device 144 may compare the amount of knee extension for the paretic leg 104 (or the prosthetic leg 320) during the stance phase to the knee extension threshold. Based on the comparison, the user device 148 or control computing device 144 may determine that the amount of knee extension for the paretic leg 104 (or the prosthetic leg 320) during the stance phase does not satisfy the knee extension threshold.

The user device 148 or the control computing device 144 may modify at least one of the electrical stimuli or the motorized assistance provided to the paretic leg 104 (or the prosthetic leg 320) during the next stance phase for the paretic leg 104 (or the prosthetic leg 320) based on the amount of knee extension during the stance phase for the paretic leg 104 (or the prosthetic leg 320) not satisfying the knee extension threshold, in order to attempt to correct the error. For example, the user device 148 or the control computing device 144 may determine an amount of adjustment and which portions of the motorized assistance and/or electrical stimuli to adjust based on the amount of knee extension not satisfying the knee extension threshold and/or the difference between the amount of knee extension for the paretic leg 104 (or the prosthetic leg 320) during the stance phase and the knee extension threshold. For example, the user device 148 or the control computing device 144 may send a signal to one or more of the motors 128, 152 or 328, 352, electrodes 130A-B, 132, 204a-n, and/or to the pulse generator 202 to indicate one or more adjusted settings or outputs for the motorized assistance and/or the electrical stimuli in response to the amount of knee extension for the paretic leg during the stance phase not satisfying the knee extension threshold.

Modifying at least one of the electrical stimuli or the motorized assistance to the paretic leg 104 (or the prosthetic leg 320) may comprise at least one of modifying a time to supply the electrical stimuli to the paretic leg 104 (or the remaining portion of the thigh of the amputated leg) during the next stance phase, modifying a level of electrical stimuli supplied to the paretic leg 104 (or the remaining portion of the thigh of the amputated leg) during the next stance phase, modifying a length of time the electrical stimuli is supplied to the paretic leg 104 (or the remaining portion of the thigh of the amputated leg) during the next stance phase, modifying a second time to supply the motorized assistance to the paretic leg 104 (or the prosthetic leg 320) during the next stance phase, modifying a level of motorized assistance to the paretic leg 104 (or the prosthetic leg 320) during the next stance phase, or modifying a second length of time the motorized assistance is supplied to the paretic leg 104 (or the prosthetic leg 320) during the next stance phase.

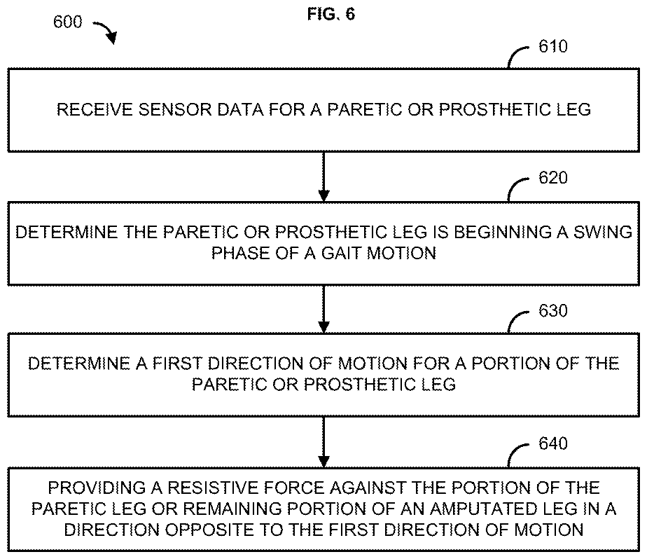

FIG. 6 shows an example method 600 for providing motorized resistance against leg movement during a gait motion of a user 102. Referring to FIGS. 1-3 and 6, the method 600 may be completed by one or more of the control computing device 144, the user device 148, or the brace 120 (or the prosthetic leg 320). The method 600 may use sensor data to evaluate the current activity of the user 102 (e.g., such as a phase of a gait motion, walking, standing, transitioning between walking and standing, etc.) and determine what, if any, motorized resistance to provide to the paretic leg 104 (or the prosthetic leg 320) of the user 102. The objective of providing the motorized resistance to the paretic leg 104 (or the prosthetic leg 320) of the user 102 while moving is to help the user 102 rebuild muscle tone and endurance in the paretic leg 104 (or the hip and remaining portion of the thigh of the amputated leg) and to improve the user's balance during movement. For example, the method 600 may determine which phase of a gait cycle the paretic leg 104 (or the prosthetic leg 320) is currently in and determine, based on that phase, what and how much motorized resistance to provide to the paretic leg 104 (or the remaining portion of the thigh of the amputated leg).

At 610, sensor data may be received. For example, the sensor data may be associated with the paretic leg 104 (or the prosthetic leg 320). For example, the sensor data may be received from one or more sensors (e.g., the sensors 129, 134-138, 154, 156 or 329, 334-338, 354, 356) located on and/or receiving data about the paretic leg 104 (or the prosthetic leg 320). For example, the sensor data may comprise a calculated estimate of a center of mass of the body of the user 102. For example, the sensor data may be received by a computing device, such as the control computing device 144 and/or the user device 148, from one or more of the sensors 129, 134-138, 154, 156 or 329, 334-338, 354, 356. The sensor data may be received at a first time. For example, the sensor data may comprise one or more of velocity data (angular velocity data) for of all or a portion of the paretic leg 104 (or the prosthetic leg 320), acceleration data of all or a portion of the paretic leg 104 (or the prosthetic leg 320), orientation data of all or a portion of the paretic leg 104 (or the prosthetic leg 320), position data for all or a portion of the paretic leg 104 (or the prosthetic leg 320), muscle activity data for all or a portion of the paretic leg 104 (or the remaining portion of the thigh of the amputated leg), or rotational relation data for one portion with respect to another portion of the paretic leg 104 (or the prosthetic leg 320). For example, the portion of the paretic leg 104 (or the prosthetic leg 320) may comprise one of the thigh portion 108 of the paretic leg 104 ((or the thigh section 322 of the prosthetic leg 320), the shank portion 110 of the paretic leg 104 (or the shank section 324 of the prosthetic leg 320), a knee portion of the paretic leg 104 (or the knee section 309 of the prosthetic leg 320), a pelvic portion of the paretic leg 104 (or hip section 350 of the prosthetic leg 320), or the foot 112 of the paretic leg 104 (or the foot section 326 of the prosthetic leg 320).

For example, the sensor data may comprise one or more of an orientation (e.g., an angle of orientation) for the thigh portion 108 of the paretic leg 104 (or the thigh section 322 of the prosthetic leg 320), an acceleration of the thigh portion 108 (or the thigh section 322), an angular velocity of the thigh portion 108 (or the thigh section 322), a position of the thigh portion 108 (or the thigh section 322), muscle activity data for the thigh portion 108 (or the remaining portion of the thigh of the amputated leg), or rotational relation data of the thigh portion 108 (or the thigh section 322) with respect to the shank portion 110 (or the shank section 324). For example, the angle of orientation for the thigh portion 108 (or the thigh section 322) may be determined based on the angle between the longitudinal axis α of the thigh portion 108 (or the thigh section 322) and one of a vertical axis and a horizontal axis. For example, the sensor data may comprise one or more of an orientation (e.g., an angle of orientation) for the shank portion 110 of the paretic leg 104 (or the shank section 324 of the prosthetic leg 320), an acceleration of the shank portion 110 (or the shank section 324), an angular velocity of the shank portion 110 (or the shank section 324), a position of the shank portion 110 (or the shank section 324), muscle activity data for the shank portion 110, or rotational relation data of the shank portion 110 (or the shank section 324) with respect to the foot 112 (or the foot section 326). For example, the angle of orientation for the shank portion 110 (or the shank section 324) may be determined based on the angle between the longitudinal axis β of the shank portion 110 (or the shank section 324) and one of a vertical axis and a horizontal axis. For example, the sensor data may comprise heel-strike or foot-floor contact data for the paretic leg 104 (or the prosthetic leg 320). For example, the sensor data may comprise position data for a pelvic portion 107 of the paretic leg 104 (or hip section 350 of the prosthetic leg 320), velocity data (e.g., angular velocity data) for the pelvic portion 107 (or hip section 350), or acceleration data for the pelvic portion 107 (or hip section 350). In certain examples, the position, velocity, acceleration, and/or angular orientation of the pelvic portion 107 (or hip section 350) may be inferred from the data for the thigh portion 108 (or the thigh section 322) and the shank portion 110 (or the shank section 324). For example, the sensor data may comprise position data for the knee portion 109 of the paretic leg 104 (or the knee section 309 of the prosthetic leg 320), velocity data (e.g., angular velocity data) for the knee portion 109 (or the knee section 309), acceleration data for the knee portion 109 (or the knee section 309), or orientation data for the knee portion 109 (or the knee section 309).

For example, the computing device, such as the control computing device 144 or the user device 148, may receive second sensor data. For example, the second sensor data may be received from one or more of the sensors 140, 142, 206 or any other sensors or encoders coupled to or associated with the non-paretic leg 106 of the user 102. For example, the second sensor data may comprise orientation data, acceleration data, velocity data (e.g., angular velocity data), position data, heel strike data, encoder data, muscle activity data, and/or foot-floor contact data for all or similar portions of the non-paretic leg 106.

At 620, a determination may be made that the paretic leg 104 (or the prosthetic leg 320) is beginning a swing phase of a gait motion for the user 102. The paretic leg 104 (or the prosthetic leg 320) beginning the swing phase may be determined by the user device 148, the control computing device 144, or any other computing device. For example, the paretic leg 104 (or the prosthetic leg 320) beginning the swing phase may be determined based on the received sensor data for the paretic leg 104 (or the prosthetic leg 320) and/or the calculated estimate of the center of mass for the body of the user 102. For example, the paretic leg 104 (or the prosthetic leg 320) beginning the swing phase may also be determined based on the received second sensor data for the non-paretic leg 106. For example, determining the paretic leg 104 (or the prosthetic leg 320) is beginning the swing phase may be determined based on an orientation of the thigh portion 108 of the paretic leg 104 (or the thigh section 322 of the prosthetic leg 320) and an angular velocity of the thigh portion 108 (or the thigh section 322). For example, determining the paretic leg 104 (or the prosthetic leg 320) is beginning a swing phase may be determined based on the orientation of the thigh portion 108 (or the thigh section 322) and the orientation of the shank portion 110 of the paretic leg 104 (or the shank section 324 of the prosthetic leg 320). For example, determining the paretic leg 104 (or the prosthetic leg 320) is beginning a swing phase may be determined based on one or more of the heel-strike or pressure data from the sensor that detects heel-strike 142 data from one or more of the sensors of the paretic leg 104 (or the prosthetic leg 320) indicating toe-off (or the toe of the paretic leg 104 (or the prosthetic leg 320) pushing off from or leaving contact with the floor surface), and/or data from one or more of the sensors of the paretic leg 104 (or the prosthetic leg 320) indicating heel-off (or the heel of the paretic leg leaving contact with the floor surface). For example, determining the paretic leg 104 (or the prosthetic leg 320) is beginning the swing phase may be determined based on the heel-strike or pressure data from the sensor that detects heel strike 142, the orientation, angular velocity, muscle activity, and/or position data for the thigh portion 108 (or the thigh section 322) from the thigh sensor 134, 334, and/or the orientation, angular velocity, muscle activity, and/or position data for the shank portion 110 (or the shank section 324) from the shank sensor 136, 336. For example, determining the paretic leg 104 (or the prosthetic leg 320) is beginning a swing phase may further be determined based on the velocity data (e.g., angular velocity data) for the shank portion 110 of the paretic leg 104 (or the shank section 324 of the prosthetic leg 320). For example, determining the paretic leg 104 (or the prosthetic leg 320) is beginning the swing phase may further be determined based on all or any portion of the position, angular velocity, or acceleration data for the pelvic portion 107 of the paretic leg 104 (or hip section 350 the prosthetic leg 320) or position, angular velocity, acceleration, or orientation data for the knee portion 109 of the paretic leg (or the knee section 309 of the prosthetic leg 320). In certain examples, the position, velocity, acceleration, and/or angular orientation of the pelvic portion 107 (or hip section 350) may be inferred from the data for the thigh portion 108 (or the thigh section 322) and the shank portion 110 (or the shank section 324). For example, determining the paretic leg 104 (or the prosthetic leg 320) is beginning the swing phase may further be determined based on all or any portion of the second sensor data associated with the non-paretic leg 106 of the user 102.

At 630, a first direction of motion for the paretic leg 104 (or the prosthetic leg 320) or portions of the paretic leg 104 (or the prosthetic leg 320) may be determined. The first direction of motion may be determined by the user device 148, the control computing device 144, or another computing device. The first direction of motion may be determined based on the paretic leg 104 (or the prosthetic leg 320) beginning the swing phase of the gait motion for the user 102. The first direction of motion may be determined based on one or more of the sensor data and the second sensor data. For example, the first direction of motion may be determined for the entire paretic leg 104 (or the prosthetic leg 320) or each of one or more portions of the paretic leg 104 (or the prosthetic leg 320). For example, the user device 148 or the control computing device 144 may determine that the thigh portion 108 of the paretic leg 104 (or the thigh section 322 of the prosthetic leg 320) has a first direction of movement of forward and downward and the shank portion 110 of the paretic leg 104 (or the shank section 324 of the prosthetic leg 320) has a first direction of movement of forward and upward, causing a rotation at the knee of the shank portion 110 (or the shank section 324) with respect to the thigh portion 108 (or the thigh section 322) in a clockwise direction. For example, the user device 148 or the control computing device 144 may determine that the thigh portion 108 of the paretic leg 104 (or the thigh section 322 of the prosthetic leg 320) has a first direction of movement of forward and downward, causing a rotation of the thigh portion 108 (or the thigh section 322) at the hip (or hip section 350) with respect to the pelvic portion (e.g., pelvis) 107 (or hip section 350) in a clockwise direction.

At 640, a resistive force against at least a portion of the paretic leg 104 (or the prosthetic leg 320) may be provided or initiated. The resistive force may be provided by the brace 120 (or the prosthetic leg 320) against the paretic leg 104 (or the remaining portion of the hip or thigh of the amputated leg). For example, the resistive force may be provided by one or more of the motors 128, 152 or 328, 352 of the brace 120 (or the prosthetic leg 320). For example, the resistive force may be provided by the motor 128, 328 in a direction opposite to the direction of motion (e.g., the first direction of motion) of all or one or more portions of the paretic leg 104 (or the prosthetic leg 320). For example, the resistive force may be provided by the motor 152, 352 in a direction opposite to the direction of motion (e.g., the first direction of motion) of all or one or more portions (e.g., the thigh potion 108 or the thigh section 322) of the paretic leg 104 (or the prosthetic leg 320). For example, in a situation during the beginning of the swing phase, where the shank portion 110 (or the shank section 324) is flexing with respect to the thigh portion 108 (or the thigh section 322), the motor 128, 328 may provide a resistive force against the motion of the shank portion 110 (or the shank section 324) in the extension direction. Conversely, in the terminal swing phase, as the shank portion 110 (or the shank section 324) is extending relative to the thigh portion 108 (or the thigh section 322), the motor 128, 328 may provide a resistive torque in the flexion direction. For example, in a situation during the beginning of the swing phase, where the thigh portion 108 (or the thigh section 322) is flexing with respect to the pelvic portion 107 (or hip section 350), the motor 152, 352 may provide a resistive force against the motion of the thigh portion 108 (or the thigh section 322) in the extension direction. For example, the user device 148 or the control computing device 144 may determine the first direction of motion for the portion of the paretic leg (e.g., the thigh portion 108 (or the thigh section 322) or the shank portion 110 (or the shank section 324)) and may send a signal to one or more of the motors 128, 152 or 328, 352 to provide a resistive force against the first direction of motion. The resistive force against the first direction of motion may be in a direction opposite to the first direction of motion or in another direction.

The user device 148 or control computing device 144 may receive third sensor data. The third sensor data may be received at a second time subsequent to the first time. The third sensor data may be received from one or more sensors (e.g., sensors 129, 134-142, 154, 156 or 329, 334-338, 354, 356) of the paretic leg 104 (or the prosthetic leg 320) or the non-paretic leg 106. The user device 148 or the control computing device 144 may further determine that the paretic leg 104 (or the prosthetic leg 320) is ending a swing phase of the gait motion for the user 102. The determination may be based on one or more portions of the third sensor data. For example, the user device 148 or the control computing device 144 may determine the paretic leg 104 (or the prosthetic leg 320) is ending the swing phase based on third sensor data associated with one or more of the thigh portion 108 (or the thigh section 322), the pelvic portion 107 (or hip section 350), or the knee portion 109 (or the knee section 309). The determination may further be based on third sensor data associated with the shank portion 110 of the non-paretic leg 106 The user device 148 or the control computing device 144 may send a signal to one or more of the motors 128, 152 or 328, 352 and cause the one or more motors 128, 152 or 328, 352 to terminate providing a resistive force against the motion of all or a portion of the paretic leg 104 (or the prosthetic leg 320). Based on the third sensor data, the user device 148 or the control computing device 144 may determine that all or portions of the paretic leg 104 (or the prosthetic leg 320) need motorized assistance and/or electrical stimuli during the end portion of the swing phase or in the transition from the swing phase to the stance phase of the gait motion. In response, the user device 148 or the control computing device 144 may send a signal to one or more of the motors 128, 152 or 328, 352, the electrodes 130A-B, 132, 204a-n, or to the pulse generator 202 to provide motorized assistance and/or electrical stimuli to the paretic leg 104 (or the prosthetic leg 320) in substantially the same manner as described hereinabove.

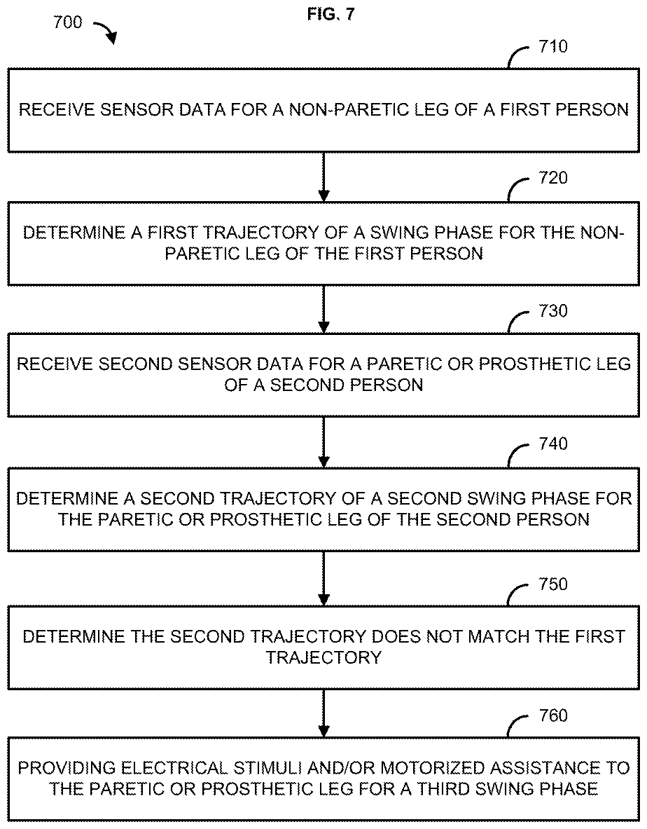

FIG. 7 shows an example method 700 for providing motorized assistance or electrical stimuli for leg movement. Referring to FIGS. 1-3 and 7, the method 700 may be completed by one or more of the control computing device 144, the user device 148, the brace 120 (or the prosthetic leg 320), or the pulse generator 202. The method 700 may use sensor data of a non-paretic leg of a first person or user to determine a target trajectory for different phases of a gait motion. The method 700 may use second sensor data of a paretic leg 104 (or the prosthetic leg 320) of a second person or user to determine the current trajectory of the paretic leg 104 (or the prosthetic leg 320) through one or more phases of the gait motion and determine whether to provide, and to what extent to provide, one or more of electrical stimuli or motorized assistance to all or certain portions of the paretic leg 104 (or the prosthetic leg 320) of the second person.

For example, one or more target sensors (not shown) may be applied to one or more portions of a non-paretic leg of a first person. For example, the first person may be physical therapist or other person working with the second person who has a paretic leg 104 (or the prosthetic leg 320). The target sensors may be applied to a non-paretic leg of the first person that matches the paretic leg 104 (or the prosthetic leg 320) of the second person. For example, if the second person's left leg is the paretic leg 104 (or the prosthetic leg 320), then the target sensors may be placed on or associated with portions of the left leg of the first person (e.g. the therapist). The one or more target sensors can be substantially the same as the sensors 129, 134-138, 154, 156 or 329, 334-338, 354, 356 (and any additional sensors on the paretic leg such as pelvic sensors or knee sensors) on the paretic leg 104 (or the prosthetic leg 320) of the second person. The target sensors may be communicably coupled to the user device 148 and/or the control computing device 144 to provide target sensor data to the user device 148 and/or the control computing device 144.

At 710, target sensor data may be received. For example, the target sensor data may be associated with the non-paretic leg of a first person (e.g., a person without a paretic leg, such as a physical therapist). For example, the target sensor data may be received from one or more target sensors located on and/or receiving data about the non-paretic leg of the first person. For example, the target sensor data may be received by a computing device, such as the control computing device 144 and/or the user device 148, from one or more of the target sensors (e.g., sensors or encoders similar to the sensors 129, 134-138, 154, 156 of FIG. 1 or 329, 334-338, 354, 356 of FIG. 3). The target sensor data may be received at a first plurality of times during each phase of the gait motion for the first person. For example, the target sensor data may comprise one or more of velocity data (e.g., angular velocity data) for of all or a portion of the non-paretic leg of the first person, acceleration data of all or a portion of the non-paretic leg of the first person, orientation data of all or a portion of the non-paretic leg of the first person, position data for all or a portion of the non-paretic leg of the first person, or rotational relation data for one portion with respect to another portion of the non-paretic leg of the first person. For example, the portion of the non-paretic leg may comprise one of the pelvic portion, thigh portion, the knee portion, the shank portion, or the foot of the non-paretic leg of the first person.

For example, the target sensor data may comprise one or more of a position, angular velocity, or acceleration of the pelvic portion; an orientation (e.g., an angle of orientation), angular velocity, acceleration, muscle activity, or position for the thigh portion; rotational relation data of the thigh portion with respect to the shank portion; position, angular velocity, or acceleration of the knee portion; orientation (e.g., an angle of orientation), position, angular velocity, muscle activity, or acceleration for the shank portion; rotational relation data of the shank portion with respect to the foot; or heel-strike or foot-floor contact data for the foot of the non-paretic leg of the first person. In certain examples, the position, velocity, acceleration, and/or angular orientation of the pelvic portion may be inferred from the data for the thigh portion and the shank portion.

At 720, a target trajectory of a swing phase for the non-paretic leg of the first person may be determined. For example, the target trajectory may be determined by the user device 148, the control computing device 144, or another computing device. For example, the target trajectory may be determined based on the target sensor data received by the user device 144 or the control computing device 144 from the one or more target sensors on the non-paretic leg of the first user. For example, the target trajectory may be determined based on the target sensor data received during a target swing phase (e.g., a representative swing phase) of the non-paretic leg for the first person. For example, the user device 148 or the control computing device 144 may determine a target trajectory for multiple portions of the leg, such as a target pelvic trajectory, a target thigh trajectory, a target knee trajectory, a target shank trajectory, and/or a target foot trajectory.

At 730, second sensor data may be received. For example, the second sensor data may be associated with the paretic leg 104 (or the prosthetic leg 320) of a second person (e.g., the user 102) different from the first person. For example, the second sensor data may be received from one or more sensors (e.g., the sensors 129, 134-138, 154, 156 or 329, 334-338, 354, 356) located on and/or receiving data about the paretic leg 104 (or the prosthetic leg 320) of the second person. For example, the second sensor data may be received by a computing device, such as the control computing device 144 and/or the user device 148, from one or more of the sensors 129, 134-138, 154, 156 or 329, 334-338, 354, 356. The second sensor data may be received at a second plurality of times that are subsequent to the first plurality of times that the target sensor data is received. For example, the second sensor data may comprise one or more of velocity data (e.g., angular velocity data) for of all or a portion of the paretic leg 104 (or the prosthetic leg 320), acceleration data of all or a portion of the paretic leg 104, orientation data of all or a portion of the paretic leg 104 (or the prosthetic leg 320), position data for all or a portion of the paretic leg 104 (or the prosthetic leg 320), muscle activity for all or a portion of the paretic leg 104 (or the hip and/or remaining portion of the thigh of the amputated leg), or rotational relation data for one portion with respect to another portion of the paretic leg 104 while the person is walking with the paretic leg 104 (or the prosthetic leg 320). For example, the portion of the paretic leg 104 may comprise one of the pelvic portion 107 (or hip section 350), the thigh portion 108 (or the thigh section 322), the knee portion 109 (or the knee section 309), the shank portion 110 (or the shank section 324) or the foot 112 of the paretic leg 104 (or the foot section 326 of the prosthetic leg 320). For example, the portion of the prosthetic leg 320 may comprise one of a hip section 350, a thigh section 322, a shank section 324, a foot section 326, or a knee section 309 (or the knee section 309).

For example, the second sensor data may comprise one or more of a position, angular velocity, or acceleration of the pelvic portion 107 (or hip section 350); an orientation (e.g., an angle of orientation), angular velocity, acceleration, muscle activity, or position for the thigh portion 108 (or the thigh section 322); rotational relation data of the thigh portion 108 (or the thigh section 322) with respect to the shank portion 110 (or the shank section 324); position, angular velocity, or acceleration of the knee portion 109 (or the knee section 309); orientation (e.g., an angle of orientation), position, angular velocity, muscle activity, or acceleration for the shank portion 110 (or the shank section 324); rotational relation data of the shank portion 110 (or the shank section 324) with respect to the foot 112 (or the foot section 326); or heel-strike or foot-floor contact data for the foot 112 of the paretic leg 104 (or the foot section 326 of the prosthetic leg 320) of the second person. In certain examples, the position, velocity, acceleration, and/or angular orientation of the pelvic portion 107 (or hip section 350) may be inferred from the data for one or more of the thigh portion 108 (or the thigh section 322) and the shank portion 110 (or the shank section 324).

At 740, a second trajectory of a second swing phase for the paretic leg 104 (or the prosthetic leg 320) of the second person may be determined. For example, the second trajectory may be determined by the user device 148, the control computing device 144, or another computing device. For example, the second trajectory may be determined based on the second sensor data received by the user device 144 or the control computing device 144 from the one or more sensors (e.g., the sensors 129, 134-138, 154, 156 or 329, 334-338, 354, 356) on the paretic leg 104 (or the prosthetic leg 320) of the second user. For example, the second trajectory may be determined based on the second sensor data received during the second swing phase of the paretic leg 104 (or the prosthetic leg 320) for the second person. For example, the user device 148 or the control computing device 144 may determine the second trajectory for multiple portions of the leg, such as a second pelvic trajectory, a second thigh trajectory, a second knee trajectory, a second shank trajectory, and/or a second foot trajectory.

At 750, a determination may be made that the second trajectory does not match (or is not within one or more thresholds) of the target trajectory. For example, the determination may be made by the user device 148, the control computing device 144, or another computing device. For example, the determination may be based on a comparison of the second trajectory of the paretic leg 104 (or the prosthetic leg 320) of the second person to the target trajectory of the non-paretic leg of the first person. For example, the determination may be made with respect to the entire target trajectory or a portion of the target trajectory during the swing phase of the gait motion. For example, the user device 148 or the control computing device 144 may compare the second trajectory (e.g., position, angular velocity, acceleration, rotational relation, muscle activity, and/or angle of orientation of the pelvic 107 (or hip section 350), thigh 108 (or the thigh section 322), knee 109 (or the knee section 309), shank 110 (or the shank section 324), and/or foot 112 (or the foot section 326) portions) of the second swing phase of the paretic leg 104 (or the prosthetic leg 320) to the target trajectory of the first swing phase (e.g., optimal angular velocity, optimal position, optimal acceleration, optimal rotational relation, and/or optimal angle of orientation of the pelvic, thigh, knee, shank, and/or foot portions) of the non-paretic leg of the first person. Based on a determination that the second trajectory of the second swing phase of the paretic leg 104 (or the prosthetic leg 320) does not match or is not within one or more predetermined trajectory or position thresholds for the target trajectory, the user device 148 or control computing device 144 may determine that the paretic leg 104 (or the prosthetic leg 320) is not moving properly or efficiently through the swing phase. For example, the positions, velocities, or accelerations of the pelvic portion 107 of the paretic leg 104 (or the hip section 350 of the prosthetic leg 320) through the second swing phase may be compared to the target positions, velocities, or accelerations of the pelvic portion of the non-paretic leg (or hip section 350) through the first swing phase; the positions, velocities, muscle activity, or accelerations of the thigh portion 108 of the paretic leg 104 (or the thigh section 322 of the prosthetic leg 320) through the second swing phase may be compared to the target positions, velocities, orientations, muscle activity, or accelerations of the thigh portion of the non-paretic leg through the first swing phase; the positions, velocities, or accelerations of the knee portion 109 of the paretic leg 104 (or the prosthetic leg 320) through the second swing phase may be compared to the target positions, velocities, or accelerations of the knee portion of the non-paretic leg through the first swing phase; the positions, velocities, orientations, muscle activity, or accelerations of the shank portion 110 of the paretic leg 104 (or the shank section 324 of the prosthetic leg 320) through the second swing phase may be compared to the target positions, velocities, muscle activity, or accelerations of the shank portion of the non-paretic leg through the first swing phase; and/or the positions, velocities, heel-strikes, foot-floor contacts, muscle activity, or accelerations of the foot 112 of the paretic leg 104 (or the foot section 326 of the prosthetic leg 320) through the second swing phase may be compared to the target positions, velocities, heel-strikes, foot-floor contacts, muscle activity, or accelerations of the foot of the non-paretic leg through the first swing phase. Further, the user device 148 or the control computing device 144 may determine the amount of difference between all or any portions of the second trajectory and the target trajectory.

Based on the determination that the second trajectory does not match (or is not within one or more thresholds) of the target trajectory and/or based on the amount of difference between the second trajectory (or portions thereof) and the target trajectory (or portions thereof), the user device 148 or the control computing device 144 may determine which of the motorized assistance and/or the electrical stimuli to provide and how much assistance or electrical stimulus to provide. For example, the user device 148 or the control computing device 144 can compare the amount of difference between the second trajectory (or portions thereof) and the target trajectory (or portions thereof) and the location and/or phase of the gait motion where the difference was detected to a database of gait adjustment parameters in or accessible to the user device 148 and/or the control computing device 144 to determine whether to provide one or both of the motorized assistance or the electrical stimuli and the amount and location (e.g. for electrical stimuli) for providing the motorized assistance or electrical stimuli.

At 760, the user device 148 or the control computing device 144 may provide at least one of the electrical stimuli or the motorized assistance to the paretic leg 104 (or the prosthetic leg 320) during the next swing phase for the paretic leg 104 (or the prosthetic leg 320) in order to attempt to correct the difference between the second trajectory and the target trajectory. For example, the electrical stimuli and/or the motorized assistance may be provided based on the second trajectory being different from (or not within one or more trajectory thresholds of) the target trajectory. For example, the user device 148 or the control computing device 144 may send a signal to one or more of the motors 128, 152 or 328, 352, electrodes 130A-B, 132, 204a-n, and/or to the pulse generator 202 to indicate one or more settings or outputs for providing the motorized assistance and/or the electrical stimuli. For example, the modification may be based on the analysis of the database of gait adjustment parameters and the amount of difference between the second trajectory (or portions thereof) and the target trajectory (or portions thereof) detected.

For example, the user device 148 or the control computing device 144 may receive additional target data during a stance phase for the non-paretic leg of the first person and additional sensor data for a second stance phase of the paretic leg 104 (or the prosthetic leg 320) of the second person. The user device 148 or the control computing device 144 may determine target trajectory and second trajectory information for the stance phase in substantially the same manner as described above, may determine any differences in the target stance trajectory and the second stance trajectory in substantially the same manner as described above, and may determine whether to provide and the amount of electrical stimuli and/or motorized assistance to provide to the paretic leg based on the comparison of the target stance trajectory and the second stance trajectory for the paretic leg 104 (or the prosthetic leg 320) in substantially the same manner as described above.

The user device 148 or the control computing device 144 may receive additional sensor data for subsequent swing phases and/or the stance phases of the paretic leg 104 (or the prosthetic leg 320) from the sensors (e.g., sensors 129, 134-138, 154, 156 or 329, 334-338, 354, 356) associated with the paretic leg 104 (or the prosthetic leg 320). The user device 148 or the control computing device 144 may determine subsequent swing phase trajectories and/or stance phase trajectories based on the additional sensor data in substantially the same manner as described above. The user device 148 or the control computing device 144 may compare these subsequent swing phase trajectories or stance phase trajectories to the corresponding target swing trajectory or target stance trajectory to determine any differences in the trajectories in substantially the same manner as described above. Further, the user device 148 or the control computing device 144 may determine any modifications to the provision of electrical stimuli and/or motorized assistance to the paretic leg 104 (or the prosthetic leg 320) based on the comparison of the corresponding paretic leg trajectories to the target trajectories in substantially the same manner as described above.

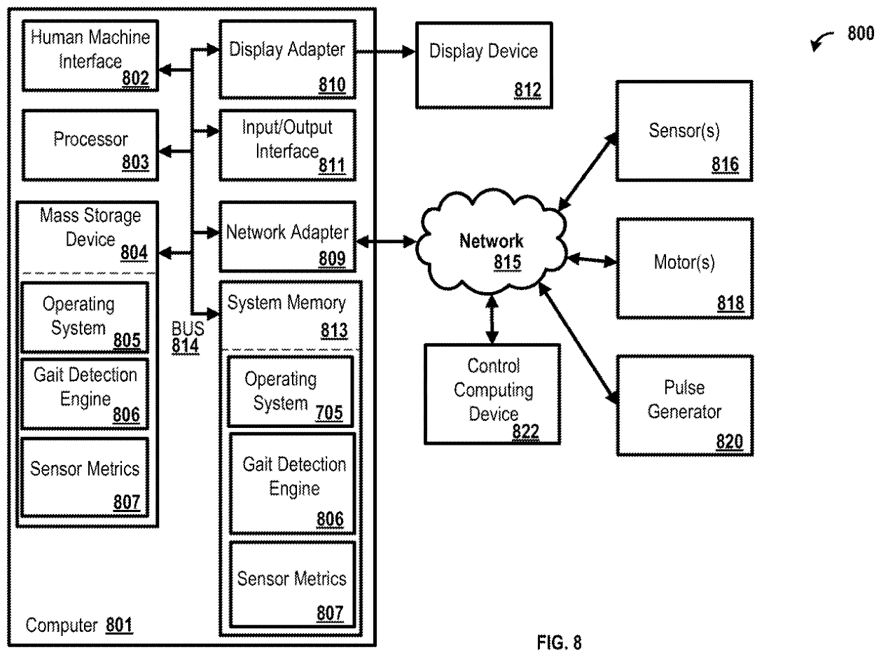

FIG. 8 shows a system 800 for providing assistance or resistance for leg movement. The user device 148, the control computing device 144, or another computing device may be a computer 801 as shown in FIG. 8.

The computer 801 may comprise one or more processors 803, a system memory 813, and a bus 814 that couples various components of the computer 801 including the one or more processors 803 to the system memory 813. In the case of multiple processors 803, the computer 801 may utilize parallel computing.

The bus 814 may comprise one or more of several possible types of bus structures, such as a memory bus, memory controller, a peripheral bus, an accelerated graphics port, and a processor or local bus using any of a variety of bus architectures.

The computer 801 may operate on and/or comprise a variety of computer-readable media (e.g., non-transitory). Computer-readable media may be any available media that is accessible by the computer 801 and includes, non-transitory, volatile and/or non-volatile media, and removable and non-removable media. The system memory 813 has computer-readable media in the form of volatile memory, such as random access memory (RAM), and/or non-volatile memory, such as read-only memory (ROM). The system memory 813 may store data and/or program modules such as an operating system 805, the gait detection engine 806, and sensor metrics 807 that are accessible to and/or are operated on by the one or more processors 803.

The computer 801 may also comprise other removable/non-removable, volatile/non-volatile computer storage media. The mass storage device 804 may provide non-volatile storage of computer code, computer-readable instructions, data structures, program modules, and other data for the computer 801. The mass storage device 804 may be a hard disk, a removable magnetic disk, a removable optical disk, magnetic cassettes or other magnetic storage devices, flash memory cards, CD-ROM, digital versatile disks (DVD) or other optical storage, RAM, ROM, electrically erasable programmable read-only memory (EEPROM), and the like.

Any number of program modules may be stored on the mass storage device 804. An operating system 805, the gait detection engine 806, and sensor metrics 807 may be stored on the mass storage device 804. One or more of the operating system 805, gait detection engine 806, and sensor metrics 807 (or some combination thereof) may comprise one or more program modules.

A user 102 may enter commands and information into the computer 801 via an input device. Such input devices may include, but are not limited to, a keyboard, pointing device (e.g., a computer mouse or remote control), a microphone, a joystick, a scanner, tactile input devices such as gloves, and other body coverings, a motion sensor, and the like These and other input devices may be connected to the one or more processors 803 via a human-machine interface 802 that is coupled to the bus 814, but may be connected by other interface and bus structures, such as a parallel port, game port, an IEEE 1394 Port (also known as a Firewire port), a serial port, network adapter 809, and/or a universal serial bus (USB).

A display device 812 may also be connected to the bus 814 via an interface, such as a display adapter 810. It is contemplated that the computer 801 may have zero displays or more than one display adapter 810 and the computer 801 may have more than one display device 812. A display device 812 may be a monitor, an LCD (Liquid Crystal Display), a light-emitting diode (LED) display, a television, smart lens, smart glass, /d/ or a projector. In addition to the display device 812, other output peripheral devices may comprise components such as speakers (not shown) and a printer (not shown) which may be connected to the computer 801 via Input/Output Interface 811. Any step and/or result of the methods may be output (or caused to be output) in any form to an output device. Such output may be any form of visual representation, including, but not limited to, textual, graphical, animation, audio, tactile, and the like. The display 812 and computer 801 may be part of one device, or separate devices.

The computer 801 may operate in a networked environment using logical connections to one or more other devices, such as the one or more sensors 816, one or more motors 818, and/or a pulse generator 820. The one or more sensors 816 may comprise the sensors 129, 134-142, 154, 156 of FIG. 1 or 329, 334-338, 354, 356 of FIG. 3. The one or more motors 818 may comprise one or both of the motors 128, 152 or 328, 352, and the pulse generator 820 may comprise the pulse generator 202 of FIG. 2. Logical connections between the computer 801, the one or more sensors 816, the one or more motors 818, and the pulse generator 820 may be made via a network 815, such as a local area network (LAN) and/or a general wide area network (WAN) and one or more network devices (e.g., a router, an edge device, an access point or other common network nodes, such as a gateway). Such network connections may be through a network adapter 809. The network adapter 809 may be implemented in both wired and wireless environments. Such networking environments are conventional and commonplace in dwellings, offices, enterprise-wide computer networks, intranets, and the Internet.

Application programs and other executable program components such as the operating system 805, the gait detection engine 806, and the sensor metrics 807 are shown herein as discrete blocks, although it is recognized that such programs and components may reside at various times in different storage components of the computing device 801, and are executed by the one or more processors 803 of the computer 801. Any of the disclosed methods may be performed by processor-executable instructions embodied on computer-readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, by a computing device, sensor data associated with one of a paretic leg or a prosthetic leg of a user;
determining, based on the sensor data, a current phase of a gait motion for the one of the paretic leg or the prosthetic leg; and
providing, based on the current phase of the gait motion of the one of the paretic leg or the prosthetic leg, at least one of electrical stimuli or motorized assistance to the one of the paretic leg or the prosthetic leg.

2. The method of claim 1, wherein the current phase of the gait motion for the one of the paretic leg or the prosthetic leg is determined to be a swing phase, and wherein providing the at least one of the electrical stimuli or the motorized assistance comprises providing the at least one of the electrical stimuli or the motorized assistance to the one of the paretic leg or the prosthetic leg for the swing phase of the gait motion.

3. The method of claim 2, further comprising:
receiving, second sensor data associated with the one of the paretic leg or the prosthetic leg;
determining, based on the second sensor data, an error with at least a portion of a trajectory of the swing phase of the gait motion for the one of the paretic leg or the prosthetic leg; and
modifying, based on the determination of the error, at least one of the electrical stimuli or the motorized assistance to the one of the paretic leg or the prosthetic leg for a next swing phase of the one of the paretic leg or the prosthetic leg.

4. The method of claim 3, wherein modifying the at least one of the electrical stimuli or the motorized assistance to the one of the paretic leg or the prosthetic leg comprises at least one of modifying a time to supply the electrical stimuli to one of the paretic leg or a remaining portion of an amputated leg during the next swing phase, modifying a level of electrical stimuli supplied to the one of the paretic leg or the remaining portion of the amputated leg during the next swing phase, modifying a length of time the electrical stimuli is supplied to the one of the paretic leg or the remaining portion of the amputated leg during the next swing phase, modifying a second time to supply the motorized assistance to the one of the paretic leg or the prosthetic leg during the next swing phase, modifying a level of motorized assistance to the one of the paretic leg or the prosthetic leg during the next swing phase, or modifying a second length of time the motorized assistance is supplied to the one of the paretic leg or the prosthetic leg during the next swing phase.

5. The method of claim 3, wherein determining the error with the at least the portion of the trajectory of the swing phase of the gait motion for the one of the paretic leg or the prosthetic leg comprises:
determining, based on the second sensor data, a time of a knee extension during the swing phase of the one of the paretic leg or the prosthetic leg;
determining, based on the second sensor data, a maximum elevation of a toe region prior to the time during the swing phase of the one of the paretic leg or the prosthetic leg;
determining, based on the second sensor data, a second maximum elevation of the toe region after the time during the swing phase of the one of the paretic leg or the prosthetic leg; and
determining the second maximum elevation is greater than the maximum elevation,
wherein modifying, based on the determination of the error, the at least one of the electrical stimuli or the motorized assistance to the one of the paretic leg or the prosthetic leg for the next swing phase of the paretic leg comprises modifying, based on the second maximum elevation being greater than the maximum elevation, the at least one of the electrical stimuli or the motorized assistance to the one of the paretic leg or the prosthetic leg for the next swing phase of the one of the paretic leg or the prosthetic leg.

6. The method of claim 3, wherein determining the error with the at least the portion of the trajectory of the swing phase of the gait motion for the one of the paretic leg or the prosthetic leg comprises:
determining, based on the second sensor data, an orientation of a thigh portion of the one of the paretic leg or the prosthetic leg at a time of the swing phase for the one of the paretic leg or the prosthetic leg; and
determining the orientation of the thigh portion is incorrect at the time of the swing phase,
wherein modifying, based on the determination of the error, the at least one of the electrical stimuli or the motorized assistance to the one of the paretic leg or the prosthetic leg for the next swing phase of the one of the paretic leg or the prosthetic leg comprises modifying, based on the orientation of the thigh portion being incorrect at the time of the swing phase, the at least one of the electrical stimuli or the motorized assistance to the one of the paretic leg or the prosthetic leg for the next swing phase of the one of the paretic leg or the prosthetic leg.

7. (canceled)

8. The method of claim 3, wherein determining the error with the at least the portion of the trajectory of the swing phase of the gait motion for the one of the paretic leg or the prosthetic leg comprises:
determining, based on the second sensor data, a time of an initiation of a knee extension of the one of the paretic leg or the prosthetic leg during the swing phase; and
determining the time of the initiation of the knee extension of the one of the paretic leg or the prosthetic leg is one of earlier than a target time or later than the target time,
wherein modifying, based on the determination of the error, the at least one of the electrical stimuli or the motorized assistance to the one of the paretic leg or the prosthetic leg for the next swing phase of the one of the paretic leg or the prosthetic leg comprises modifying, based on the time of the initiation of the knee extension of the one of the paretic leg or the prosthetic leg being the one of earlier than the target time or later than the target time, the at least one of the electrical stimuli or the motorized assistance to the one of the paretic leg or the prosthetic leg for the next swing phase of the one of the paretic leg or the prosthetic leg.

9. The method of claim 3, wherein determining the error with the at least the portion of the trajectory of the swing phase of the gait motion for the one of the paretic leg or the prosthetic leg comprises:
determining, based on the second sensor data, a position of a pelvic portion of the one of the paretic leg or the prosthetic leg at a first time during the swing phase; and
determining the position of the pelvic portion is incorrect at the first time of the swing phase,
wherein modifying, based on the determination of the error, the at least one of the electrical stimuli or the motorized assistance to the one of the paretic leg or the prosthetic leg for the next swing phase of the one of the paretic leg or the prosthetic leg comprises modifying, based on the position of the pelvic portion being incorrect at the first time of the swing phase, the at least one of the electrical stimuli or the motorized assistance to the one of the paretic leg or the prosthetic leg for the next swing phase of the one of the paretic leg or the prosthetic leg.

10. The method of claim 1, wherein the current phase of the gait motion for the one of the paretic leg or the prosthetic leg is determined to be a stance phase, and wherein providing the at least one of the electrical stimuli or the motorized assistance comprises providing the at least one of the electrical stimuli or the motorized assistance to the one of the paretic leg or the prosthetic leg for the stance phase of the gait motion.

11. The method of claim 10, further comprising:
receiving second sensor data associated with the one of the paretic leg or the prosthetic leg;
determining, based on the second sensor data, an error with at least a portion of a trajectory of the stance phase of the gait motion for the one of the paretic leg or the prosthetic leg; and
modifying, based on the determination of the error, at least one of the electrical stimuli or the motorized assistance to the one of the paretic leg or the prosthetic leg for a next stance phase of the one of the paretic leg or the prosthetic leg.

12. The method of claim 11, wherein modifying the at least one of the electrical stimuli or the motorized assistance to the one of the paretic leg or the prosthetic leg comprises at least one of modifying a time to supply the electrical stimuli to one of the paretic leg or a remaining portion of an amputated leg during the next stance phase, modifying a level of electrical stimuli supplied to the one of the paretic leg or the remaining portion of the amputated leg during the next stance phase, modifying a length of time the electrical stimuli is supplied to the one of the paretic leg or the remaining portion of the amputated leg during the next stance phase, modifying a second time to supply the motorized assistance to the one of the paretic leg or the prosthetic leg during the next stance phase, modifying a level of motorized assistance to the one of the paretic leg or the prosthetic leg during the next stance phase, or modifying a second length of time the motorized assistance is supplied to the one of the paretic leg or the prosthetic leg during the next stance phase.

13. The method of claim 11, wherein determining the error with the at least the portion of the trajectory of the stance phase of the gait motion for the one of the paretic leg or the prosthetic leg comprises:
determining, based on the second sensor data, an amount of knee extension of the one of the paretic leg or the prosthetic leg during the stance phase; and
determining the amount of knee extension does not satisfy a knee extension threshold,
wherein modifying, based on the determination of the error, the at least one of the electrical stimuli or the motorized assistance to the one of the paretic leg or the prosthetic leg for the next stance phase of the one of the paretic leg or the prosthetic leg comprises modifying, based on the amount of knee extension not satisfying the knee extension threshold, the at least one of the electrical stimuli or the motorized assistance to the one of the paretic leg or the prosthetic leg for the next stance phase of the one of the paretic leg or the prosthetic leg.

14. The method of claim 1, wherein providing the motorized assistance comprises providing, by a brace device coupled to the paretic leg, the motorized assistance to the paretic leg.

15. (canceled)

16. (canceled)

17. (canceled)

18. The method of claim 1, further comprising:
receiving, by the computing device, second sensor data associated with a non-paretic leg of the user,
wherein determining, the current phase of the gait motion of the one of the paretic leg or the prosthetic leg is further based on the second sensor data.

19. The method of claim 1, wherein the current phase of the gait motion of the one of the paretic leg or the prosthetic leg comprises one of a heel-strike phase, a foot flat phase, a midstance phase, a heel off phase, a toe off phase, a swing phase, or a stance phase.

20. (canceled)

21. A method comprising:
receiving, by a computing device, sensor data associated with one of a paretic leg or a prosthetic leg;
determining, based on the sensor data, the one of the paretic leg or the prosthetic leg is in a stance phase of a gait motion; and
providing at least one of electrical stimuli or motorized assistance to the one of the paretic leg or the prosthetic leg for the stance phase of the gait motion.

22. The method of claim 21, further comprising:
receiving, second sensor data associated with the one of the paretic leg or the prosthetic leg;
determining, based on the second sensor data, an error with at least a portion of a trajectory of the stance phase of the gait motion for the one of the paretic leg or the prosthetic leg; and
modifying, based on the determination of the error, at least one of the electrical stimuli or the motorized assistance to the one of the paretic leg or the prosthetic leg for a next stance phase of the one of the paretic leg or the prosthetic leg.

23. The method of claim 22, wherein modifying the at least one of the electrical stimuli or the motorized assistance to the one of the paretic leg or the prosthetic leg comprises at least one of modifying a time to supply the electrical stimuli to one of the paretic leg or a remaining portion of an amputated leg during the next stance phase, modifying a level of electrical stimuli supplied to the one of the paretic leg or the remaining portion of the amputated leg during the next stance phase, modifying a length of time the electrical stimuli is supplied to the one of the paretic leg or the remaining portion of the amputated leg during the next stance phase, modifying a second time to supply the motorized assistance to the one of the paretic leg or the prosthetic leg during the next stance phase, modifying a level of motorized assistance to the one of the paretic leg or the prosthetic leg during the next stance phase, or modifying a second length of time the motorized assistance is supplied to the one of the paretic leg or the prosthetic leg during the next stance phase.

24. (canceled)

25. (canceled)

26. (canceled)

27. A method comprising:
receiving, by a computing device, first sensor data associated with a non-paretic leg of a first person;
determining, based on the first sensor data, a first trajectory of a swing phase for the non-paretic leg of the first person;
receiving, by the computing device, second sensor data associated with one of a paretic leg or a prosthetic leg of a second person;
determining, based on the second sensor data, a second trajectory of a second swing phase for the one of the paretic leg or the prosthetic leg of the second person;
determining the second trajectory does not match the first trajectory; and
providing, based on the second trajectory not matching the first trajectory, at least one of electrical stimuli or motorized assistance to the one of the paretic leg or the prosthetic leg for a third swing phase for the one of the paretic leg or the prosthetic leg of the second person.

28. The method of claim 27, further comprising:
receiving, by the computing device, third sensor data associated with the one of the paretic leg or the prosthetic leg of the second person;
determining, based on the third sensor data, a third trajectory of the third swing phase for the one of the paretic leg or the prosthetic leg of the second person;
determining the third trajectory does not match the first trajectory; and
modifying, based on the third trajectory not matching the first trajectory, at least one of the electrical stimuli or the motorized assistance to the one of the paretic leg or the prosthetic leg for a fourth swing phase for the one of the paretic leg or the prosthetic leg of the second person.
